(19) United States
(12) Patent Application Publication
(10) Pub. No.: US 2024/0317936 A1
(43) Pub. Date: Sep. 26, 2024

(54) COMPOUND, COMPOSITION, SURFACE TREATMENT AGENT, COATING LIQUID, ARTICLE, AND METHOD FOR PRODUCING ARTICLE

(71) Applicant: AGC Inc., Tokyo (JP)

(72) Inventors: Takuya IWASE, Tokyo (JP); Motoshi AOYAMA, Tokyo (JP)

(73) Assignee: AGC Inc., Tokyo (JP)

(21) Appl. No.: 18/672,363

(22) Filed: May 23, 2024

Related U.S. Application Data
(63) Continuation of application No. PCT/JP2022/043230, filed on Nov. 22, 2022.

(30) Foreign Application Priority Data
Nov. 25, 2021 (JP) 2021-191387

(51) Int. Cl. C08G 65/336; C09D 7/65

(52) U.S. Cl. CPC C08G 65/336; C09D 7/65; C08G 2150/00

(57) ABSTRACT

A fluorine-containing ether compound represented by formula (1) or (2):

A¹-(OR^{f1})_{y1}—R¹-Q¹-R²-L¹-(R³-T¹)ₓ₁ Formula (1)

(T³-R⁹)ₓ₃-L³-R⁸-Q³-R⁷—R^{f}—(OR^{f2})_{y2}—R⁴-Q²-R⁵-L²-(R⁶-T²)ₓ₂ Formula (2)

where each symbol in the formula is as described in the description.

### INCORPORATION BY REFERENCE

This application is based upon and claims the benefit of priority from Japanese Patent Application 2021-191387 filed on Nov. 25, 2021, and PCT application No. PCT/JP2022/043230 filed on Nov. 22, 2022, the disclosure of which is incorporated herein in its entirety by reference.

### BACKGROUND

The present invention relates to a compound, a composition, a surface treating agent, a coating liquid, an article, and a method for producing an article.

Fluorine-containing ether compounds having fluorine atoms are excellent in various properties such as low refractive index, low dielectric constant, water/oil repellency, heat resistance, chemical resistance, chemical stability, and transparency, thus being used in a wide variety of fields such as electrical and electronic materials, semiconductor materials, optical materials, and surface treating agents.

For example, a fluorine-containing ether compound having a perfluoropolyether chain and a hydrolyzable silyl group is suitably used as a surface treating agent because the compound is capable of forming on a surface of a substrate a surface layer exhibiting high lubricity, water/oil repellency, and the like. A surface treating agent containing the fluorine-containing ether compound is used in an application where it is desired to maintain, for a long period of time, a performance (antifriction properties) whereby water/oil repellency is less likely to be lowered even if the surface laver is rubbed repeatedly with fingers and a performance (fingerprint stain removability) whereby a fingerprint adhering to the surface layer can be readily removed by wiping, for example, as a surface treating agent for a member constituting a plane of a touch panel to be touched with fingers, an eyeglass lens, and a display of a wearable terminal.

As a fluorine-containing ether compound which is capable of forming on the surface of a substrate a surface layer excellent in antifriction properties, a fluorine-containing ether compound having a perfluoropolyether chain and a hydrolyzable silyl group has been proposed (Japanese Unexamined Patent Application Publication No. 2016-037541).

### SUMMARY

As described above, a fluorine-containing ether compound is useful as a surface treating agents for imparting the above various physical properties, and there is an increasing demand for a fluorine-containing ether compound that can be used in various environments. The present inventors have conducted studies for the purpose of further improving antifriction properties and light resistance.

An object of the present invention is to provide a compound, a composition, a surface treating agent, a coating liquid, an article, and a method for producing an article, all of which have excellent antifriction properties and light resistance.

The present invention provides a fluorine-containing ether compound, a fluorine-containing ether composition, a coating liquid, an article, a method for producing an article, having the following constitutions [1] to [11].

[1] A compound represented by formula (1) or (2):

A¹-(OR^{f1})_{y1}—R¹-Q¹-R²-L¹-(R³-T¹)ₓ₁ Formula (1)

(T³-R⁹)ₓ₃-L³-R⁸-Q³-R⁷—R^{f}—(OR^{f2})_{y2}—R⁴-Q²-R⁵-L²-(R⁶-T²)ₓ₂ Formula (2)
in which
A¹ is a fluoroalkyl group having 1 to 20 carbon atoms;
R^{f1} is a fluoroalkylene group having 1 to 6 carbon atoms, and when there is a plurality of R^{f1}, the plurality of R^{f} is the same as or different from each other;
R¹ is a single bond or a divalent group;
Q¹ is a divalent group including one or more cyclic structures, in which atoms constituting the cyclic structures are bonded to R¹ and R²;
R² is a single bond or a divalent group;
L¹ is a single bond or a 1+x1 valent group optionally having N, O, S, or Si and a branch point, in which atoms bonded to R² and R³ are each independently a N, O, S. or Si atom, a carbon atom constituting the branch point, or a carbon atom having a hydroxy group or an oxo group (═O);
R³ is an alkylene group or an alkylene group having an etheric oxygen atom at the terminal on the L¹ side or between carbon-carbon atoms, and when there is a plurality of R³, the plurality of R³ is the same as or different from each other;
T¹ is —SiR^{a1}_{z1}R^{a11}_{3-z1};
R^{a1} is a hydroxy group or a hydrolyzable group, and when there is a plurality of R^{a1}, the plurality of R^{a1} is the same as or different from each other;
R^{a11} is a non-hydrolyzable group, and when there is a plurality of R^{a11}, the plurality of R^{a11} is the same as or different from each other;
z1 is an integer of 0 to 3, and when there is a plurality of z1, the plurality of z1 is the same as or different from each other, where at least one of z1 is an integer of 1 to 3;
x1 is an integer of 1 or more;
y1 is an integer of 1 or more;
R^{f} is a fluoroalkylene group having 1 to 6 carbon atoms;
R^{f2} is a fluoroalkylene group having 1 to 6 carbon atoms, and when there is a plurality of R^{f2}, the plurality of R^{f2} is the same as or different from each other;
R⁴ is a single bond or a divalent group;
Q² is a divalent group including one or more cyclic structures, in which atoms constituting the cyclic structures are bonded to R⁴ and R⁵;
R⁵ is a single bond or a divalent group;
L² is a single bond or a 1+x2 valent group optionally having N, O, S, or Si and a branch point, in which atoms bonded to R⁵ and R⁶ are each independently a N, O, S, or Si atom, a carbon atom constituting the branch point, or a carbon atom having a hydroxy group or an oxo group (═O);
R⁶ is an alkylene group or an alkylene group having an etheric oxygen atom at the terminal on the L² side or between carbon-carbon atoms, and when there is a plurality of R⁶, the plurality of R⁶ is the same as or different from each other;
T² is —SiR^{a2}_{z2}R^{a12}_{3-z2};
R^{a2} is a hydroxy group or a hydrolyzable group, and when there is a plurality of R^{a2}, the plurality of R^{a2} is the same as or different from each other;
R^{a12} is a non-hydrolyzable group, and when there is a plurality of R^{a12}, the plurality of R^{a12} is the same as or different from each other;
z2 is an integer of 0 to 3, and when there is a plurality of z2, the plurality of z2 is the same as or different from each other, where at least one of z2 is an integer of 1 to 3;
R¹ is a single bond or a divalent group;
Q³ is a divalent group including one or more cyclic structures, in which atoms constituting the cyclic structures are bonded to R⁷ and R⁸;
R⁸ is a single bond or a divalent group;
L³ is a single bond or a 1+x3 valent group optionally having N, O, S, or Si and a branch point, in which atoms bonded to R⁸ and R⁹ are each independently a N, O, S, or Si atom, a carbon atom constituting the branch point, or a carbon atom having a hydroxy group or an oxo group (═O);
R⁹ is an alkylene group or an alkylene group having an etheric oxygen atom at the terminal on the L³ side or between carbon-carbon atoms, and when there is a plurality of R⁹, the plurality of R⁹ is the same as or different from each other,
T³ is —SiR^{a3}_{z3}R^{a13}_{3-z3};
R^{a3} is a hydroxy group or a hydrolyzable group, and when there is a plurality of R^{a3}, the plurality of R^{a3} is the same as or different from each other;
R^{a13} is a non-hydrolyzable group, and when there is a plurality of R^{a13}, the plurality of R^{a13} is the same as or different from each other;
z3 is an integer of 0 to 3, and when there is a plurality of z3, the plurality of z3 is the same as or different from each other, where at least one of z3 is an integer of 1 to 3;
X2 and x3 are each independently an integer of 1 or more; and
y2 is an integer of 1 or more.
   [2] The compound according to [1], in which at least one of Q¹, Q², and Q³ is a divalent group containing one monocyclic or fused ring.
   [3] The compound according to [1] or [2], in which at least one of Q¹, Q², and Q³ is a divalent group having a bonding on carbon atoms adjacent to each other that form a ring.
   [4] The compound according to any one of [1] to [3], in which at least one of R¹, R⁴, and R⁷ is an alkylene group.
   [5] The compound according to any one of [1] to [4], in which at least one of R², R⁵, and R⁸ is a single bond or an alkylene group.
   [6] A composition containing the compound according to any one of [1] to [5] and another fluorine-containing ether compound.
   [7] A surface treating agent containing the compound according to any one of [1] to [5] or the composition according to [6].
   [8] A coating liquid containing the compound according to any one of [1] to [5] or the composition according to [6] and a liquid medium.
   [9] An article including: a surface laver formed of the compound according to any one of [1] to [5], the composition according to [6], or the surface treating agent according to [7] on a surface of a substrate.
   [10] A method for producing an article, including forming a surface layer by a dry coating method or a wet coating method using the compound according to any one of [1] to [5], the composition according to [6], the surface treating agent according to [7], or the coating liquid according to [8].
   [11] A compound represented by formula (3) or (4):

A¹-(OR^{f1})_{y1}—R¹-Q¹-R²¹-D¹ Formula (3)

D³-R⁸¹-Q³-R⁷—R^{f}—(OR^{f2})_{y2}—R⁴-Q²-R⁵¹-D² Formula (4)
in which
A¹ is a fluoroalkyl group having 1 to 20 carbon atoms;
R^{f1} is a fluoroalkylene group having 1 to 6 carbon atoms, and when there is a plurality of R^{f1}, the plurality of R^{f1} is the same as or different from each other;
R¹ is a single bond or a divalent group;
Q¹ is a divalent group including one or more cyclic structures, in which atoms constituting the cyclic structures are bonded to R¹ and R²;
R²¹ is a single bond or a divalent group;
D¹ is a halogen atom,
y1 is an integer of 1 or more;
R^{f} is a fluoroalkylene group having 1 to 6 carbon atoms;
R^{f2} is a fluoroalkylene group having 1 to 6 carbon atoms, and when there is a plurality of R^{f2}, the plurality of R^{f2} is the same as or different from each other;
R⁴ is a single bond or a divalent group;
Q² is a divalent group including one or more cyclic structures, in which atoms constituting the cyclic structures are bonded to R⁴ and R⁵;
R⁵¹ is a single bond or a divalent group;
R⁷ is a single bond or a divalent group;
Q³ is a divalent group including one or more cyclic structures, in which atoms constituting the cyclic structures are bonded to R⁷ and R⁸;
R⁸¹ is a single bond or a divalent group;
D² and D³ are each independently a halogen atom; and
y2 is an integer of 1 or more.

The above and other objects, features and advantages of the present disclosure will become more fully understood from the detailed description given hereinbelow and the accompanying drawings which are given by way of illustration only, and thus are not to be considered as limiting the present disclosure.

According to the present invention, it is possible to provide a compound, a composition, a surface treating agent, a coating liquid, an article, and a method for producing an article, all of which have excellent antifriction properties and light resistance.

### BRIEF DESCRIPTION OF DRAWINGS

FIG. 1 is a schematic cross-sectional view illustrating one example of an article of the present invention.

### DESCRIPTION OF EMBODIMENTS

In the present specification, a compound represented by formula (1) is referred to as compound 1. The same applies to compounds represented by other formulae.

The term “(poly)oxyfluoroalkylene” collectively refers to oxyfluoroalkylene and polyoxyfluoroalkylene.

A fluoroalkyl group is a generic term for a combination of a perfluoroalkyl group and a partial fluoroalkyl group. The perfluoroalkyl group means a group having all hydrogen atoms in an alkyl group substituted with fluorine atoms. The partial fluoroalkyl group is an alkyl group having one or more hydrogen atoms substituted with fluorine atoms and one or more hydrogen atoms. That is, the fluoroalkyl group is an alkyl group having one or more fluorine atoms.

The term “reactive silyl group” collectively refers to a hydrolyzable silyl group and a silanol group (Si—OH), and the “hydrolyzable silyl group” means a group capable of forming a silanol group by hydrolysis reaction.

An “organic group” means a hydrocarbon group that may have a substituents and a heteroatom or another bond in a carbon chain. The “hydrocarbon group” is a group composed of an aliphatic hydrocarbon group (such as a linear alkylene group, a branched alkylene group, or a cycloalkylene group), an aromatic hydrocarbon group (such as a phenylene group), or a combination thereof.

A “surface layer” means a layer formed on the surface of a substrate.

The “molecular weight” of a fluoropolyether chain is the number average molecular weight calculated from the number (average value) of oxyfluoroalkylene units on the basis of terminal groups determined by ¹H-NMR and ¹⁹F-NMR.

The expression “to” indicating a numerical range is meant to include numerical values given before and after it as a lower limit value and an upper limit value.

### [Compound]

The compound of the present invention is characterized by being represented by formula (1) or (2):

A¹-(OR^{f1})_{y1}—R¹-Q¹-R²-L¹-(R³-T¹)ₓ₁ Formula (1)

(T³-R⁹)ₓ₃-L³-R⁸-Q³-R⁷—R^{f}—(OR^{f2})_{y2}—R⁴-Q²-R⁵-L²-(R⁶-T²)ₓ₂ Formula (2)
in which
A¹ is a fluoroalkyl group having 1 to 20 carbon atoms;
R^{f1} is a fluoroalkylene group having 1 to 6 carbon atoms, and when there is a plurality of R^{f1}, the plurality of R^{f} is the same as or different from each other;
R¹ is a single bond or a divalent group;
Q¹ is a divalent group including one or more cyclic structures, in which atoms constituting the cyclic structures are bonded to R¹ and R²;
R² is a single bond or a divalent group;
L¹ is a single bond or a 1+x1 valent group optionally having N, O, S, or Si and a branch point, in which atoms bonded to R² and R³ are each independently a N, O, S, or Si atom, a carbon atom constituting the branch point, or a carbon atom having a hydroxy group or an oxo group (═O);
R³ is an alkylene group or an alkylene group having an etheric oxygen atom at the terminal on the L¹ side or between carbon-carbon atoms, and when there is a plurality of R³, the plurality of R³ is the same as or different from each other;
T¹ is —SiR^{a1}_{z1}R^{a11}_{3-z1};
R^{a1} is a hydroxy group or a hydrolyzable group, and when there is a plurality of R^{a1}, the plurality of R^{a1} is the same as or different from each other;
R^{a11} is a non-hydrolyzable group, and when there is a plurality of R^{a11}, the plurality of R^{a11} is the same as or different from each other;
z1 is an integer of 0 to 3, and when there is a plurality of z1, the plurality of z1 is the same as or different from each other, where at least one of z1 is an integer of 1 to 3;
x1 is an integer of 1 or more;
y1 is an integer of 1 or more;
R^{f} is a fluoroalkylene group having 1 to 6 carbon atoms;
R^{f2} is a fluoroalkylene group having 1 to 6 carbon atoms, and when there is a plurality of R^{f2}, the plurality of R^{f2} is the same as or different from each other;
R⁴ is a single bond or a divalent group;
Q² is a divalent group including one or more cyclic structures, in which atoms constituting the cyclic structures are bonded to R⁴ and R⁵;
R⁵ is a single bond or a divalent group;
L² is a single bond or a 1+x2 valent group optionally having N, O, S, or Si and a branch point, in which atoms bonded to R⁵ and R⁶ are each independently a N, O, S, or Si atom, a carbon atom constituting the branch point, or a carbon atom having a hydroxy group or an oxo group (═O);
R⁶ is an alkylene group or an alkylene group having an etheric oxygen atom at the terminal on the L² side or between carbon-carbon atoms, and when there is a plurality of R⁶, the plurality of R⁶ is the same as or different from each other;
T² is —SiR^{a2}_{z2}R^{a12}_{3-z2};
R^{a2} is a hydroxy group or a hydrolyzable group, and when there is a plurality of R^{a2}, the plurality of R^{a2} is the same as or different from each other;
R^{a12} is a non-hydrolyzable group, and when there is a plurality of R^{a12}, the plurality of R^{a12} is the same as or different from each other;
z2 is an integer of 0 to 3, and when there is a plurality of z2, the plurality of z2 is the same as or different from each other, where at least one of z2 is an integer of 1 to 3;
R⁷ is a single bond or a divalent group;
Q³ is a divalent group including one or more cyclic structures, in which atoms constituting the cyclic structures are bonded to R⁷ and R⁸;
R⁸ is a single bond or a divalent group;
L³ is a single bond or a 1+x3 valent group optionally having N, O, S, or Si and a branch point, in which atoms bonded to R⁸ and R⁹ are each independently a N, O, S, or Si atom, a carbon atom constituting the branch point, or a carbon atom having a hydroxy group or an oxo group (═O);
R⁹ is an alkylene group or an alkylene group having an etheric oxygen atom at the terminal on the L³ side or between carbon-carbon atoms, and when there is a plurality of R⁹, the plurality of R⁹ is the same as or different from each other;
T³ is —SiR^{a3}_{z3}R^{a13}_{3-z3};
R^{a3} is a hydroxy group or a hydrolyzable group, and when there is a plurality of R^{a3}, the plurality of R^{a3} is the same as or different from each other;
R^{a13} is a non-hydrolyzable group, and when there is a plurality of R^{a13}, the plurality of R^{a13} is the same as or different from each other;
z3 is an integer of 0 to 3, and when there is a plurality of z3, the plurality of z3 is the same as or different from each other, where at least one of z3 is an integer of 1 to 3;
X2 and x3 are each independently an integer of 1 or more; and
y2 is an integer of 1 or more.

Compound 1 has a structure of “fluoropolyether chain-linking group including a cyclic structure-reactive silyl group” in summary. Compound 2 has a structure of “reactive silyl group-linking group including a cyclic structure-fluoropolyether chain-linking group including a cyclic structure-reactive silyl group” in summary. Since the present compound has a fluoropolyether chain, a surface layer obtained by using this compound has excellent water/oil repellency and fingerprint stain removability.

This compound has a reactive silyl group. Since the reactive silyl group is strongly chemically bonded to a substrate, the resulting surface layer has excellent durability such as antifriction properties.

Compounds 1 and 2 have a fluoroether chain linked to a reactive silyl group by a linking group including a cyclic structure. The linking group including a cyclic structure can maintain a linkage between a polyfluoroether chain and a reactive silyl group even if some of the bonds in the cyclic structure are broken, for example, by friction or light irradiation. Therefore, the surface layer formed by the present compound has excellent water/oil repellency and fingerprint stain removability, as well as excellent antifriction properties and light resistance.

Hereinafter, the composition of each compound is described, but symbols having the same structure indicate the same, which may be referred to by replacing them as appropriate.

### <Compound 1>

Compound 1 has a structure represented by formula (1):

A¹-(OR^{f1})_{y1}—R¹-Q¹-R²-L¹-(R³-T¹)ₓ₁ Formula (1)
where each symbol in formula (1) is as described above.

A¹ is a fluoroalkyl group having 1 to 20 carbon atoms. The fluoroalkyl group may be a linear alkyl group or an alkyl group having a branched and/or cyclic structure. A linear fluoroalkyl group is preferable from the viewpoint of abrasion resistance properties. From the viewpoint of ease of synthesis, for example, the number of carbon atoms in the fluoroalkyl group is preferably 1 to 6 and more preferably 1 to 3.

R^{f1} is a fluoroalkylene group having 1 to 6 carbon atoms, and when there is a plurality of R^{f1}, the plurality of R^{f1} is the same as or different from each other. (OR^{f1})_{y1} is a fluoropolyether chain, in which y1 is an integer of 1 or more.

The fluoropolyether chain in (OR^{f1})_{y1} preferably has a structure represented by formula (G1):

-[(OG^{f1})ₘ₁(OG^{f2})ₘ₂(OG^{f3})ₘ₃(OG^{f4})ₘ₄(OG^{f5})ₘ₅(OG^{f6})ₘ₆]- Formula (G1)
in which
G^{f1} is a fluoroalkylene group having 1 carbon atom;
G^{f2} is a fluoroalkylene group having 2 carbon atom;
G^{f3} is a fluoroalkylene group having 3 carbon atom;
G^{f4} is a fluoroalkylene group having 4 carbon atom;
G^{f5} is a fluoroalkylene group having 5 carbon atom;
G^{f6} is a fluoroalkylene group having 6 carbon atom; and
m1, m2, m3, m4, m5, and m6 each independently represent an integer of 0 or 1 or more, and m1+m2+m3+m4+m5+m6 is an integer of 1 to 200.

Note that (OG^{f1}) to (OG^{f6}) in formula (G1) are bonded in any order. m1 to m6 in formula (G1) respectively represent the number of (OG^{f1}) to (OG^{f6}), not the arrangement. For example, (OG^{f5})ₘ₅ represents that the number of (OG^{f5}) is m5, not the block arrangement structure of (OG^{f5})ₘ₅. Similarly, the order of description of (OG^{f1}) to (OG^{f6}) does not represent the binding order of the respective units. The fluoroalkylene group having 3 to 6 carbon atoms may be a linear fluoroalkylene group or a fluoroalkylene group having a branched or cyclic structure.

Specific examples of G^{f1} include —CF₂— and —CHF—.

Specific examples of G^{f2} include —CF₂CF₂—, —CHFCF₂—, —CHFCHF—, —CH₂CF₂—, —CH₂CHF—.

Specific examples of G^{f3} include —CF₂CF₂CF₂—, —CF₂CHFCF₂—, —CF₂CH₂CF₂—, —CHFCF₂CF₂—, —CHFCHFCF₂—, —CHFCHFCHF—, —CHFCH₂CF₂—, —CH₂CF₂CF₂—, —CH₂CHFCF₂—, —CH₂CH₂CF₂—, —CH₂CF₂CHF—, —CH₂CHFCHF—, —CH₂CH₂CHF—, —CF(CF₃)—CF₂—, —CF(CHF₂)—CF₂—, —CF(CH₂F)—CF₂—, —CF(CH₃)—CF₂—, —CF(CF₃)—CHF—, —CF(CHF₂)—CHF—, —CF(CH₂F)—CHF—, —CF(CH₃)—CHF—, —CF(CF₃)—CH₂—, —CF(CHF₂)—CH₂—, —CF(CH₂F)—CH₂—, —CF(CH₃)—CH₂—, —CH(CF₃)—CF₂—, —CH(CHF₂)—CF₂—, —CH(CH₂F)—CF₂—, —CH(CH₃)—CF₂—, —CH(CF₃)—CHF—, —CH(CHF₂)—CHF—, —CH(CH₂F)—CHF—, —CH(CH₃)—CHF—, —CH(CF₃)—CH₂—, —CH(CHF₂)—CH₂—, and —CH(CH₂F)—CH₂—.

Specific examples of G^{f4} include —CF₂CF₂CF₂CF₂—, —CHFCF₂CF₂CF₂—, —CH₂CF₂CF₂CF₂—, —CF₂CHFCF₂CF₂—, —CHFCHFCF₂CF₂—, —CH₂CHFCF₂CF₂—, —CF₂CH₂CF₂CF₂—, —CHFCH₂CF₂CF₂—, —CH₂CH₂CF₂CF₂—, —CHFCF₂CHFCF₂—, —CH₂CF₂CHFCF₂—, —CF₂CHFCHFCF₂—, —CHFCHFCHFCF₂—, —CH₂CHFCHFCF₂—, —CF₂CH₂CHFCF₂—, —CHFCH₂CHFCF₂—, —CH₂CH₂CHFCF₂—, —CF₂CH₂CH₂CF₂—, —CHFCH₂CH₂CF₂—, —CH₂CH₂CH₂CF₂—, —CHFCH₂CH₂CHF—, —CH₂CH₂CH₂CHF—, and -cycloC₄F₆—.

Specific examples of G^{f5} include —CF₂CF₂CF₂CF₂CF₂—, —CHFCF₂CF₂CF₂CF₂—, —CH₂CHFCF₂CF₂CF₂—, —CF₂CHFCF₂CF₂CF₂—, —CHFCHFCF₂CF₂CF₂—, —CF₂CH₂CF₂CF₂CF₂—, —CHFCH₂CF₂CF₂CF₂—, —CH₂CH₂CF₂CF₂CF₂—, —CF₂CF₂CHFCF₂CF₂—, —CHFCF₂CHFCF₂CF₂—, —CH₂CF₂CHFCF₂CF₂—, —CH₂CF₂CF₂CF₂CH₂—, and -cycloC₅F₈—.

Specific examples of G^{f6} include —CF₂CF₂CF₂CF₂CF₂CF₂—, —CF₂CF₂CHFCHFCF₂CF₂—, —CHFCF₂CF₂CF₂CF₂CF₂—, —CHFCHFCHFCHFCHFCHF—, —CHFCF₂CF₂CF₂CF₂CH₂—, —CH₂CF₂CF₂CF₂CF₂CH₂— and -cycloC₆F₁₀—.

Here, -cycloC₄F₆— means a perfluorocyclobutanediyl group, specific examples of which include a perfluorocyclobutane-1,2-diyl group. -cycloC₅F₈— means a perfluorocyclopentandiyl group, specific examples of which include a perfluorocyclopentane-1,3-diyl group. -cycloC₆F₁₀— means a perfluorocyclohexanediyl group, specific examples of which include a perfluorocyclohexane-1,4-diyl group.

(OR^{f1})_{y1} preferably has a structure represented by, in particular, formulae (G2) to (G4) from the viewpoint of superior water/oil repellency, antifriction properties, and fingerprint stain removability.

(OG^{f1})ₘ₁-(OG^{f2})ₘ₂ Formula (G2)

(OG^{f2})ₘ₂-(OG^{f4})ₘ₄ Formula (G3)

(OG^{f3})ₘ₃ Formula (G4)

where each symbol in formulae (G2) to (G4) is the same as in formula (G1) above.

In Formula (G2) and Formula (G3), (OG^{f1}) and (OG^{f2}), and (OG^{f2}) and (OG^{f4}) are bonded in any order, respectively. For example, (OG^{f1}) and (OG^{f2}) may be alternately arranged, and (OG^{f1}) and (OG^{f2}) may each be arranged in a block or randomly. The same applies to formula (G3).

In formula (G2), m1 is preferably 1 to 50 and more preferably 1 to 30. m2 is preferably 1 to 50 and more preferably 1 to 30.

In formula (G3), m2 is preferably 1 to 50 and more preferably 1 to 30. m4 is preferably 1 to 50 and more preferably 1 to 30.

In formula (G4), m3 is preferably 1 to 50 and more preferably 1 to 30.

In the fluoropolyether chain (OR^{f1})_{y1}, the proportion of fluorine atoms [{number of fluorine atoms/(number of fluorine atoms+number of hydrogen atoms)}×100 (%)] is preferably 60% or more, more preferably at 70% or more, and even more preferably 80% or more, from the viewpoint of excellent water/oil repellency and fingerprint removability.

The molecular weight of the fluoropolyether chain (OR^{f1})_{y1} moiety is preferably 200 to 30,000. more preferably 600 to 25,000, and even more preferably 1000 to 20.000, from the viewpoint of abrasion resistance properties.

Note that the carbon atom bonded to R¹ or Q¹ in R^{f1} is bonded to at least one fluorine atom.

R¹ is a single bond or a divalent group.

When R¹ is a single bond, the present compound has a structure in which R^{f1} located at the end of the fluoroalkylene chain is directly bonded to Q¹.

When R¹ is a divalent group. R¹ includes, for example, a bond B¹ selected from —O—, —S—, —C(═O)NR^{N}—, —NR^{N}C(═O)—, —C(═O)O—, —OC(═O)—, and —C(═O)—; and an alkylene group that may have the bond B¹ at the terminal on the R^{f1} side, the terminal on the Q¹ side, or between carbon-carbon atoms.

However, R^{N} is a hydrogen atom, an alkyl group having 1 to 6 carbon atoms, or a phenyl group.

The alkylene group may be linear or branched. A linear alkylene group is preferable from the viewpoint of abrasion resistance properties. From the viewpoint of ease of synthesis, for example, the number of carbon atoms in the alkylene group is preferably 1 to 6 and more preferably 1 to 3. The bond B¹ which the alkylene group may have is preferably —O—. R¹ is preferably a group represented by formula (g1) from the viewpoint of synthetic easiness:

*—R³¹—(O—R³²)ₐ₁—** Formula (g1)
in which
R³¹ is a single bond or a linear alkylene group having 1 to 6 carbon atoms;
R³² is a linear alkylene group having 1 to 6 carbon atoms;
a1 is an integer of 0 to 3; and
* is a bonding on the R^{f1} side, and ** is a bonding on the Q¹ side.

Note that when R³¹ is an alkylene group, the carbon atom of R^{f1} bonded to R³¹ is bonded to one or more fluorine atoms.

Furthermore, R¹ is preferably a group represented by formula (g1a) from the viewpoint of synthetic easiness:

*—(O)ₐ₂—R³³—** Formula (g1a)
in which
R³³ is a linear alkylene group having 1 to 6 carbon atoms;
a2 is an integer of 0 or 1; and
* is a bonding on the R^{f1} side, and ** is a bonding on the Q¹ side.

Note that when a2 is 0, the carbon atom of R^{f1} bonded to R³³ is bonded to one or more fluorine atoms.

Moreover, from the viewpoint of ease of synthesis, for example, R¹ is preferably an alkylene group, and more preferably a linear alkylene group having 1 to 3 carbon atoms.

Q¹ is a divalent group including one or more cyclic structures, in which atoms constituting the cyclic structures are bonded to R¹ and R². Specifically, Q¹ is represented by formula (Q1):

*-J¹-(R^{J1}-J²)ₖ₁-** Formula (Q1)
in which
J¹ and J² are each independently a cyclic structure, and when there is a plurality of J², J² are the same as or different from each other;
R^{J1} is a single bond or a divalent group, and when there is a plurality of R^{J1}, R^{J1} are the same as or different from each other;
k1 is an integer of 0 or more; and
* is a bonding on the R¹ side, and ** is a bonding on the R² side.

The cyclic structures J¹ and J² in Q¹ may be either a monocyclic structure or a fused ring structure, may have a heteroatom, and may further have a crosslinked structure in the cyclic structure. Examples of the heteroatom include O, N, S, and Si. From the viewpoint of stability of the cyclic structure, each cyclic structure is preferably a 3- to 1-membered ring, more preferably a 4- to 8-membered ring, and even more preferably a 5- to 8-membered ring.

Examples of the monocyclic structure include a structure derived from an aromatic ring, such as benzene, furan, thiophene, pyrrole, pyran, pyridine, pyrazole, oxazole, imidazole, and thiazole; a structure derived from an aliphatic ring that may have a double bond, such as cyclopropane, cyclobutane, cyclopentane, cyclopentene, cyclohexane, and cyclohexene; a structure derived from a cyclic ether, such as oxetane, tetrahydrofuran, and tetrahydropyran; and a structure derived from a cyclic amine, such as pyrrolidine, pyrrolidone, and piperidine.

Examples of the fused ring structure include a structure derived from a polycyclic aromatic ring, such as naphthalene, anthracene, benzofuran, thionaphthene, carbazole, benzopyrone, quinoline, acridine, phthalazine, and quinoxaline; a structure derived from a fused aliphatic ring, such as decahydronaphthalene; and a fused ring of an aromatic ring and an aliphatic ring, such as tetralin.

Examples of the structure having a crosslinked structure in the cyclic structure include norbornane, bicyclo[2.2.2]octane, and adamantane.

Note that the cyclic structure in JP and J² refers to a structure in which any two hydrogen atoms of the ring each serve as a bonding.

When R^{J1} is a divalent group, R^{J1} include, for example, a bond B² selected from —O—, —S—, —C(═O)NR^{N1}—, —NR^{N1}C(═O)—, —C(═O)O—, —OC(═O)—, and —C(═O)—; and an alkylene group that may have the bond B² at the terminal on the J side, the terminal on the J² side, or between carbon-carbon atoms and also have a carbon-carbon double bond.

However, R^{N1} is a hydrogen atom or an alkyl group having 1 to 6 carbon atoms.

k1 is an integer of 0 or more. When k1 is 0, Q¹ is a group consisting only of the cyclic structure J¹, i.e., a group including one monocyclic or fused ring structure. When k1 is 1 or more, Q¹ is a group with a plurality of cyclic structures linked. Specific examples of such Q¹ include structures derived from biphenyl, terphenyl, diphenylmethane, stilbene, and diphenyl ether.

From the viewpoint of synthetic easiness, antifriction properties, and light resistance, k1 is preferably 0 to 2, more preferably 0 to 1, and even more preferably 0.

The cyclic structure in Q¹ is preferably a carbocyclic structure having no heteroatoms from the viewpoint of, for example, antifriction properties and light resistance.

From the viewpoint the ease of synthesis, antifriction properties, and light resistance, the cyclic structure in Q¹ is preferably a divalent group having a bonding on carbon atoms adjacent to each other that form a ring. However, the cyclic structure in Q¹ may be, but is not limited to a structure in which carbon atoms adjacent to each other that form a ring have a bonding, a structure in which carbon atoms not adjacent to each other that form a ring have a bonding, for example.

Specific examples of the cyclic structure in Q¹ include the following structure.

However, R^{Q} may be a protective group protecting an amino group contained in the cyclic structure, a monovalent hydrocarbon group, and a bonding which is bonded to R¹ or R². Each n1 is independently an integer of 1 to 3.

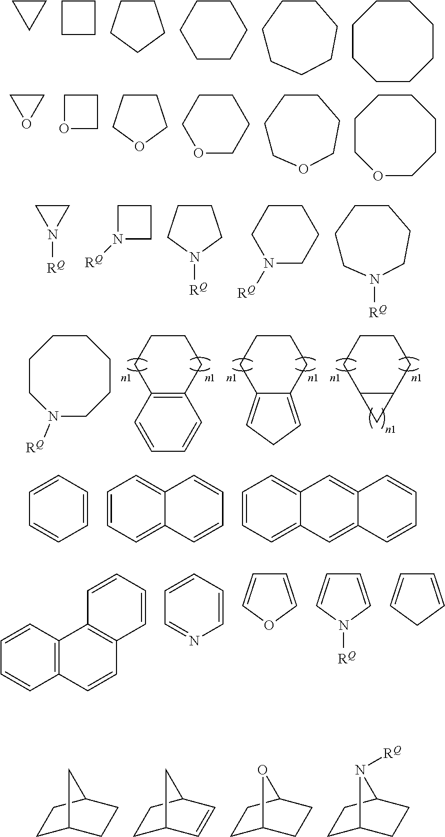

R² is a single bond or a divalent group.

When R² is a single bond, the present compound has a structure in which Q¹ is directly bonded to L¹.

When R² is a divalent group, R² includes, for example, a bond B³ selected from —O—, —S—, —C(═O)NR^{N2}—, —NR^{N2}C(O)—, —C(═O)O—, —OC(═O)—, —C(═O)—, —NR²—, —SO₂NR^{N2}—, —Si(R^{N2})₂—, and —OSi(R^{N2})₂; and an alkylene group that may have the bond B³ at the terminal on the Q¹ side, the terminal on the L¹ side, or between carbon-carbon atoms.

However, R^{N2} is a hydrogen atom, an alkyl group having 1 to 6 carbon atoms, or a phenyl group.

The alkylene group may be linear or branched. A linear alkylene group is preferable from the viewpoint of abrasion resistance properties. From the viewpoint of ease of synthesis, for example, the number of carbon atoms in the alkylene group is preferably 1 to 6 and more preferably 1 to 3. The bond B¹ which the alkylene group may have is preferably —O—. R² is preferably a group represented by formula (g2) from the viewpoint of synthetic easiness:

*—R³⁴—(O—R³⁵)ₐ₃—** Formula (g2)
in which
R³⁴ is a linear alkylene group having 1 to 6 carbon atoms;
R³⁵ is a linear alkylene group having 1 to 6 carbon atoms, and when there is a plurality of R¹⁴, the plurality of R³⁴ is the same as or different from each other;
a3 is an integer of 0 to 3; and
* is a bonding on the Q¹ side, and ** is a bonding on the L¹ side.

Moreover, from the viewpoint of ease of synthesis, for example, R² is preferably an alkylene group, and more preferably a linear alkylene group having 1 to 3 carbon atoms.

L¹ is a single bond or a 1+x1 valent group optionally having N, O, S, or Si and a branch point, in which atoms bonded to R² and R³ are each independently a N, O, S, or Si atom or a carbon atom forming a hydroxy group or a branch point.

When L¹ is a single bond, R² and R³ in formula (1) are directly bonded.

When L¹ is a trivalent or higher-valent group, L¹ has at least one branch point selected from the group consisting of C, N, Si, a cyclic structure, and a (1+x1) valent organopolysiloxane residue (hereinafter referred to as “branch point P¹”).

When N is a branch point P¹, the branch point P¹ is represented by, for example, *—N(—**)₂ where * is a bonding on the R² side, and ** is a bonding on the R¹ side.

When C is the branch point P¹, the branch point P¹ is represented by, for example, *—C(—**)₃ or *—CR²⁹(—**)₂, where * is a bonding on the R² side; ** is a bonding on the R³ side; and R²⁹ is a monovalent group such as a hydrogen atom, a hydroxy group, an alkyl group, and an alkoxy group.

When Si is the branch point P¹, the branch point P¹ is represented by, for example, *—Si(—**)₃ or *—SiR²⁹(—**)₂, where * is a bonding on the R² side, ** is a bonding on the R³ side, and R²⁹ is a monovalent group such as a hydrogen atom, a hydroxy group, an alkyl group, and an alkoxy group.

The cyclic structure constituting the branch point P¹ is preferably one selected from the group consisting of a 3- to 8-membered aliphatic ring, a 3- to 8-membered aromatic ring, a 3- to 8-membered heterocyclic ring, and a fused ring composed of two or more of these rings, and particularly preferably a cyclic structure represented by formulae below, from the viewpoint of easy production of the present compound and further excellent antifriction properties, light resistance, and chemical resistance of the surface layer. The cyclic structure may have a substituent such as a halogen atom, an alkyl group (which may contain an etheric oxygen atom between carbon-carbon atoms), a cycloalkyl group, an alkenyl group, an allyl group, an alkoxy group, and an oxo group (═O).

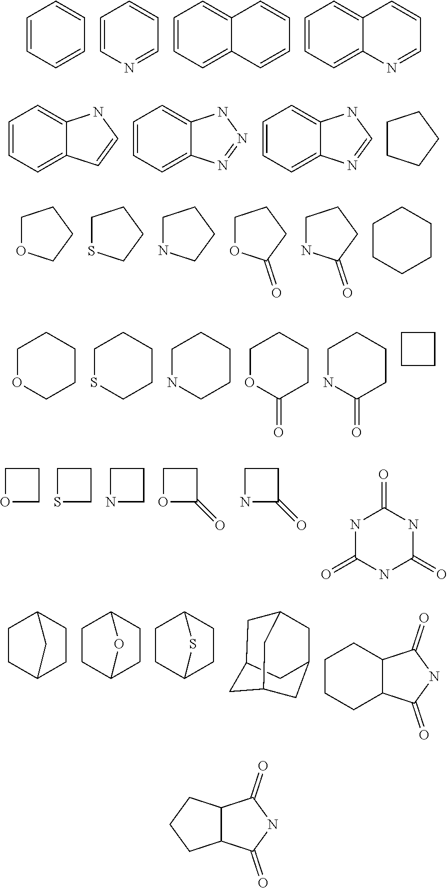

Examples of the organopolysiloxane residue constituting the branch point P¹ include the following groups, provided that R²⁵ in formulae below is a hydrogen atom, an alkyl group, an alkoxy group, or a phenyl group. The number of carbon atoms in the alkyl group and the alkoxy group of R²⁵ is preferably 1 to 10, and more preferably 1.

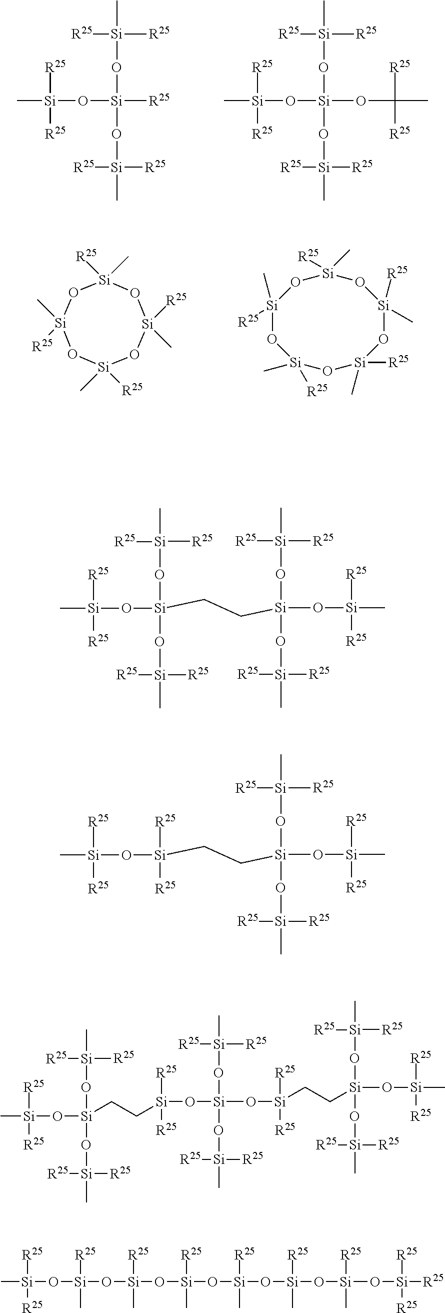

The divalent or higher-valent L¹ may have at least one bond (hereinafter referred to as “bond B⁴”) selected from the group consisting of —C(O)N(R²⁶)—, —N(R²⁶)C(O)—, —C(O)O—, —OC(O)—, —C(O)—, —O—, —N(R²⁶)—, —S—, —OC(O)O—, —NHC(O)O—, —OC(O)NH—, —NHC(O)N(R²⁶)—, —SO₂N(R²⁶)—, —N(R²⁶)SO₂—, —Si(R²⁶)₂—, —OSi(R²⁶)₂—, —Si(CH₃)₂-Ph-Si(CH₃)₂—, and a divalent organopolysiloxane residue.

However, R²⁶ is a hydrogen atom, an alkyl group having 1 to 6 carbon atoms, or a phenyl group, and Ph is a phenylene group. The number of carbon atoms in the alkyl group of R²⁶ is preferably 1 to 6, more preferably 1 to 3, and even more preferably 1 or 2 from the viewpoint of easy production of the present compound.

Examples of the divalent organopolysiloxane residue include groups below, provided that R²⁷ in formulae below is a hydrogen atom, an alkyl group, an alkoxy group, or a phenyl group. The number of carbon atoms in the alkyl group and the alkoxy group of R²⁷ is preferably 1 to 10, and more preferably 1.

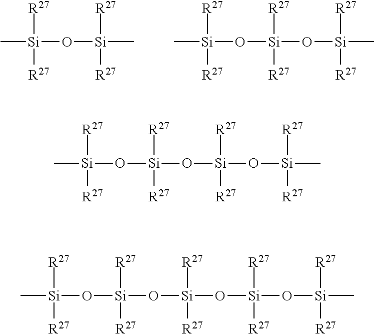

The bond B⁴ is preferably at least one bond selected from the group consisting of —C(O)NR²⁶—, —N(R²⁶)C(O)—, —C(O)—, and —NR²⁶— from the viewpoint of easy production of the present compound, and is more preferably —C(O)NR²⁶—, —N(R²⁶)C(O)—, or —C(O)— from the viewpoint of further excellent light resistance and chemical resistance of the surface layer.

In the trivalent or higher-valent L¹, atoms bonded to R² and R³ are each independently a N, O, S, or Si atom, a carbon atom constituting a branch point, or a carbon atom having an oxo group (═O). In other words, the atoms adjacent to R² and R³ are each a constituent element of the bond B⁴ or branch point P¹. Specific examples of the trivalent or higher-valent L¹ include one or more branch points P¹ (e.g., {*—P¹(—**)₁} and a combination of one or more branch points P¹ and one or more bonds B⁴ (e.g., {*—B⁴—R²⁸—P¹ (—**)ₓ₁}, {*—B⁴—R²⁸—P¹(—R²⁸—B⁴—**)ₓ₁}), where R²⁸ is a single bond or a divalent organic group; * is a bonding on the R² side; and ** is a bonding on the R³ side.

In the divalent L¹, atoms bonded to R² and R³ are each independently a N, O, S, or Si atom, or a carbon atom having an oxo group (═O). In other words, the atoms adjacent to R² and R³ are each a constituent element of the bond B⁴. Specific examples of the divalent or higher-valent L¹ include a single bond, one or more bonds B⁴ (e.g., *—B⁴—**, *—B⁴—R²⁸—B⁴—**), where R²⁸ is a single bond or a divalent organic group; * is a bonding on the R² side; and ** is a bonding on the R³ side.

Examples of the divalent organic group in R²⁸ include a divalent aliphatic hydrocarbon group (an alkylene group, a cycloalkylene group, etc.) and a divalent aromatic hydrocarbon group (a phenylene group, etc.), and the divalent organic group may have a bond B⁴ between carbon-carbon atoms of a hydrocarbon group having 2 or more carbon atoms. The number of carbon atoms in the divalent organic group is preferably 1 to 10, more preferably 1 to 6, and even more preferably 1 to 4.

L¹ is preferably a group represented by any one of formulae (E1) to (E7) below from the viewpoint of easy production of the present compound.

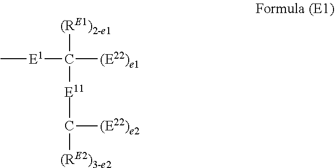

-E¹—C(R^{E2})₃₋ₑ₃(-E²²-)ₑ₃ Formula (E2)

-E²—N(-E²³-)₂ Formula (E3)

-E³-Z¹(-E²⁴-)ₑ₄ Formula (E4)

-E²—Si(R^{E3})₃₋ₑ₃(-E²⁵-)ₑ₃ Formula (E5)

-E¹-E²⁶- Formula (E6)

-E¹—CH(-E²²-)—Si(R^{E3})₃₋ₑ₅(-E^{2S}-)ₑ₅ Formula (E7)

However, in formulae (E1) to (E7), the E¹, E², or E³ side is connected to R² in formula (1), and the E²², E²³, E²⁴, E²⁵, or E²⁶ side is connected to R³.

Here, E¹ is a single bond, —B⁵—, —B⁶—R⁴⁰—, or —B⁶—R⁴⁰—B⁵—, in which R⁴⁰ is an alkylene group or a group having —C(O)NR^{E6}—, —C(O)—, —NR^{E6}—, or —O— between carbon-carbon atoms of an alkylene group having two or more carbon atoms, and B¹ is —C(O)NR^{E6}—, —C(O)—, —NR^{E6}—, or —O—;
B⁶ is —C(O)NR^{E6}—, —C(O)—, or —NR^{E6}—;
E² is a single bond or —B⁶—R⁴⁰—;
E³ is E¹ when the atom in Z¹ to which E³ is bonded is a carbon atom, and is E² when the atom in Z¹ to which E³ is bonded is a nitrogen atom;
E¹¹ is a single bond, —O—, an alkylene group, or a group having —C(O)NR^{E6}—, —C(O)—, —NR^{E6}—, or —O— between carbon-carbon atoms of an alkylene group having two or more carbon atoms;
E²² is a single bond, —B⁵—, —R⁴⁰—B⁶—, or —B⁵—R⁴⁰—B⁶—, and when there are two or more E²²′, two or more Q²²′ are optionally the same or different;
E²³ is a single bond or —R⁴⁰—B⁶—, and two E²³′ are optionally the same or different;
E²⁴ is E²² when the atom in Z¹ to which E²⁴ is bonded is a carbon atom, and is E²³ when the atom in Z¹ to which E²⁴ is bonded is a nitrogen atom, and when there are two or more E²⁴′, two or more E²⁴′ are optionally the same or different;
E²⁵ is a single bond or —R⁴⁰—B⁶—, and when there are two or more E²⁵′, two or more E²⁵′ are optionally the same or different;
E²⁶ is a single bond or —R⁴⁰—B⁶—;
Z¹ is a group having an (e4+1)-valent cyclic structure with a carbon atom or nitrogen atom to which E³ is directly bonded and a carbon atom or nitrogen atom to which E²⁴ is directly bonded;
R^{E1} is a hydrogen atom or an alkyl group, and when there are two or more R^{E1}, two or more R^{E1} are optionally the same or different;
R^{E2} is a hydrogen atom, a hydroxy group, an alkyl group, or an acyloxy group;
R^{E3} is an alkyl group;
R^{E6} is a hydrogen atom, an alkyl group having 1 to 6 carbon atoms, or a phenyl group;
   e1 is an integer of 0 to 3, e2 is an integer of 0 to 3, and e1+e2 is an integer of 1 to 6;
   e3 is an integer of, 1 to 3;
   e4 is an integer of 1 or more; and
   e5 is an integer of 1 to 3.

Note that e1+e2=x1, e3=x1, e4=x1, and e5=x1.

The number of carbon atoms in the alkylene group of R⁴⁰ is preferably 1 to 10, more preferably 1 to 6, and even more preferably 1 to 4 from the viewpoint of easy production of the present compound and further excellent antifriction properties, light resistance, and chemical resistance of the surface layer, provided that the lower limit value of the number of carbon atoms in the alkylene group is 2 when it has a specific bond between carbon-carbon atoms.

The cyclic structure in Z¹ include the (e4+1)-valent residue of the cyclic structure constituting the branch point P¹ described above, and the preferred embodiments are also the same. Since E²⁴ is directly bonded to the cyclic structure in Z¹. E²⁴ is never connected to, for example, an alkylene group connected to the cyclic structure.

The number of carbon atoms in the alkyl group of RE, R^{E2}, or R^{E3} is preferably 1 to 6, more preferably 1 to 3, and even more preferably 1 or 2 from the viewpoint of easy production of the present compound.

The number of carbon atoms in the alkyl group moiety in the acyloxy group of R^{E2} is preferably 1 to 6, more preferably 1 to 3, and even more preferably 1 or 2 from the viewpoint of easy production of compound 1.

g4 is preferably 2 to 6, more preferably 2 to 4, and even more preferably 2 or 3 from the viewpoint of easy production of the present compound and further excellent antifriction properties and fingerprint stain removability of the surface layer.

Another embodiment of L¹ includes a group represented by any one of formulae (E11) to (E¹⁷) below.

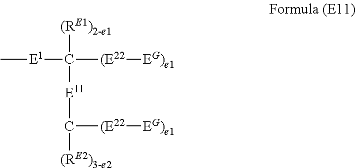

-E¹—C(R^{E2})₃₋ₑ₃(-E²²-E^{G})ₑ₃ Formula (E12)

-E²—N(-E²³-E^{G})₂ Formula (E13)

-E³-Z¹(-E²⁴-E^{G})ₑ₄ Formula (E14)

-E²—Si(R^{E3})₃₋ₑ₃(-E²⁵-E^{G})ₑ₃ Formula (E15)

-E¹-E²⁶-E^{G} Formula (E16)

-E¹—CH(-E²²-)—Si(R^{E3})₃₋ₑ₅(-E²⁵-E^{G})ₑ₅ Formula (E17)

However, in formulae (E11) to (E17), the E¹, E², or E³ side is connected to R² in formula (1), and the E²², E²³, E²⁴, E²⁵, or E²⁶ side is connected to R³. E^{G} is of the following formula (E³), and two or more E^{G}′ contained in L¹ are optionally the same or different. The symbols other than G are the same as the symbols in formulae (E1) to (E7).

—Si(R²³)₃₋ₖ(-E³-)ₖ Formula (E^{G})

However, in formula (E^{G}), the Si side is connected to E²², E²³, E²⁴, E²⁵, or E²⁶, and the E³ side is connected to R³. R²³ is an alkyl group. E³ is a single bond or —R⁴⁵—B⁶—, in which R⁴³ is an alkylene group, a group having —C(O)NR⁴⁶—, —C(O)—, —NR⁴⁶— or —O— between carbon-carbon atoms of an alkylene group having two or more carbon atoms, or —(OSi(R²⁴)₂)ₚ—O—, and two or more E³′ are optionally the same or different. k is 2 or 3. R⁴⁶ is a hydrogen atom, an alkyl group having 1 to 6 carbon atoms, or a phenyl group. R²⁴ is an alkyl group, a phenyl group, or an alkoxy group, and two R²⁴′ are optionally the same or different. P is an integer of 0 to 5, and when p is 2 or more, two or more (OSi(R²⁴)₂)′ are optionally the same or different.

The number of carbon atoms in the alkylene group of E³ is preferably 1 to 10, more preferably 1 to 6, and even more preferably 1 to 4 from the viewpoint of easy production of the present compound and further excellent antifriction properties, light resistance, and chemical resistance of the surface layer, provided that the lower limit value of the number of carbon atoms in the alkylene group is 2 when it has a specific bond between carbon-carbon atoms.

The number of carbon atoms in the alkyl group of R²³ is preferably 1 to 6, more preferably 1 to 3, and even more preferably 1 or 2 from the viewpoint of easy production of the present compound.

The number of carbon atoms in the alkyl group of R²⁴ is preferably 1 to 6, more preferably 1 to 3, and even more preferably 1 to 2 from the viewpoint of easy production of the present compound.

The number of carbon atoms in the alkoxy group of R²⁴ is preferably 1 to 6, more preferably 1 to 3, and even more preferably 1 or 2 from the viewpoint of excellent storage stability of the present compound.

P is preferably 0 or 1.

R³ is an alkylene group in which the atom bonded to L¹ may be an etheric oxygen atom or may have an etheric oxygen atom between carbon-carbon atoms, and when there is a plurality of R³, the plurality of R³ is the same as or different from each other. R³ is preferably a group represented by formula (g5):

*—(O)ₐ₄—(R^{g1}O)ₐ₅—R^{g2}—** (g5)
in which
R^{g1} is a alkylene group having 1 to 12 carbon atoms, and a plurality of R^{g1} is the same as or different from each other;
R⁸² is an alkylene group having 1 to 18 carbon atoms;
a4 is 0 or 1;
a5 is an integer of 0 or more;
* is a bonding which is bonded to L¹; and
** is a bonding which is bonded to T.

When a4 is 0, an atom having the bonding * is a carbon atom, and when a3 is 1, an atom having the bonding * is an oxygen atom. In the present compound, a3 may be either 0 or 1 and may be appropriately selected in view of, for example, synthesis.

a5 represents the number of repetitions of R^{g1}O, and is preferably 0 to 6, more preferably 0 to 3, and even more preferably 0 or 1 from the viewpoint of durability as a surface layer and the like.

The alkylene group of R^{g2} may be a linear or branched alkylene group having 1 to 12 carbon atoms, preferably an alkylene group having 1 to 6 carbon atoms, and more preferably an alkylene group having 1 to 3 carbon atoms. Alternatively, the alkylene group is preferably a linear alkylene group.

The alkylene group of R^{g2} may be a linear or branched alkylene group having 1 to 18 carbon atoms, preferably an alkylene group having 1 to 12 carbon atoms, more preferably an alkylene group having 1 to 8 carbon atoms, even more preferably an alkylene group having 2 to 6 carbon atoms, and particularly preferably an alkylene group having 2 or 3 carbon atoms. Alternatively, the alkylene group is preferably a linear alkylene group.

T¹ is —SiR^{a1}_{z1}R^{a11}_{3-z1}.

R^{a1} is a hydroxy group or a hydrolyzable group, and when there is a plurality of R^{a1}′, the plurality of R^{a1} is the same as or different from each other; R^{a11} is a non-hydrolyzable group, and when there is a plurality of R^{a11}, the plurality of R^{a11} is the same as or different from each other.

z1 is an integer of 0 to 3, and when there is a plurality of z1, the plurality of z1 is the same as or different from each other, where at least one of z1 is an integer of 1 to 3.

When R^{a1} is a hydroxy group, it forms a silanol (Si—OH) group together with a Si atom. The hydrolyzable group is a group converted to a hydroxy group by hydrolysis reaction. Silanol groups further react between molecules to form Si—O—Si bonds. A silanol group undergoes dehydration condensation reaction with a hydroxy group (substrate-OH) on the surface of a substrate to form a chemical bond (substrate-O—Si). The compound A1 has excellent abrasion resistance properties after formation of the surface layer due to having one or more T^{1′}.

Examples of the hydrolyzable group of R^{a1} include an alkoxy group, an aryloxy group, a halogen atom, an acyl group, an acyloxy group, and an isocyanate group (—NCO). The alkoxy group is preferably an alkoxy group having 1 to 4 carbon atoms. The acyl group is preferably an acyl group having 1 to 6 carbon atoms. The acyloxy group is preferably an acyloxy group having 1 to 6 carbon atoms.

R^{a1} is preferably an alkoxy group having 1 to 4 carbon atoms or a halogen atom from the viewpoint of easy production of the present compound. The alkoxy group in R^{a1} is preferably an alkoxy group having 1 to 4 carbon atoms from the viewpoint of excellent storage stability of the present compound and suppression of outgassing during reaction, particularly preferably an ethoxy group from the viewpoint of long-term storage stability, and especially preferably a methoxy group from the viewpoint of shortening the hydrolysis reaction time. Alternatively, the halogen atom is preferably a chlorine atom.

The non-hydrolyzable group of R^{a11} is a hydrogen atom or a monovalent hydrocarbon group. Examples of the hydrocarbon group include an alkyl group, a cycloalkyl group, an alkenyl group, and an allyl group; and an alkyl group is preferable from the viewpoint of ease of production and the like. The number of carbon atoms in the hydrocarbon group is preferably 1 to 6, more preferably 1 to 3, and even more preferably 1 to 2.

The number z1 of R^{a1} in one T¹ may be 1 to 3, preferably 2 or 3, and more preferably 3 from the viewpoint of adhesion to the substrate. Specific examples of T¹ include —Si(OCH₃)₃, —SiCH₃(OCH₃)₂, —Si(OCH₂CH₃)₃, —SiCl₃, —Si(OCOCH₃)₃, and —Si(NCO)₃, —Si(OCH₃)₃ is particularly preferable from the viewpoint of ease of handling in production.

The number x1 of T¹ in one molecule of compound 1 may be 1 to 20, and x1 is preferably 1 to 12 and more preferably 1 to 6 from the viewpoint of ease of synthesis, ease of handling of compound A1, and the like.

When there are two or more T¹ in one molecule of compound 1, T¹ may have the same structure as or different structures from each other.

Specific examples of the compound 1 include the following,

provided that each n is independently an integer of 1 or more, and each n1 is independently an integer of 1 to 3.

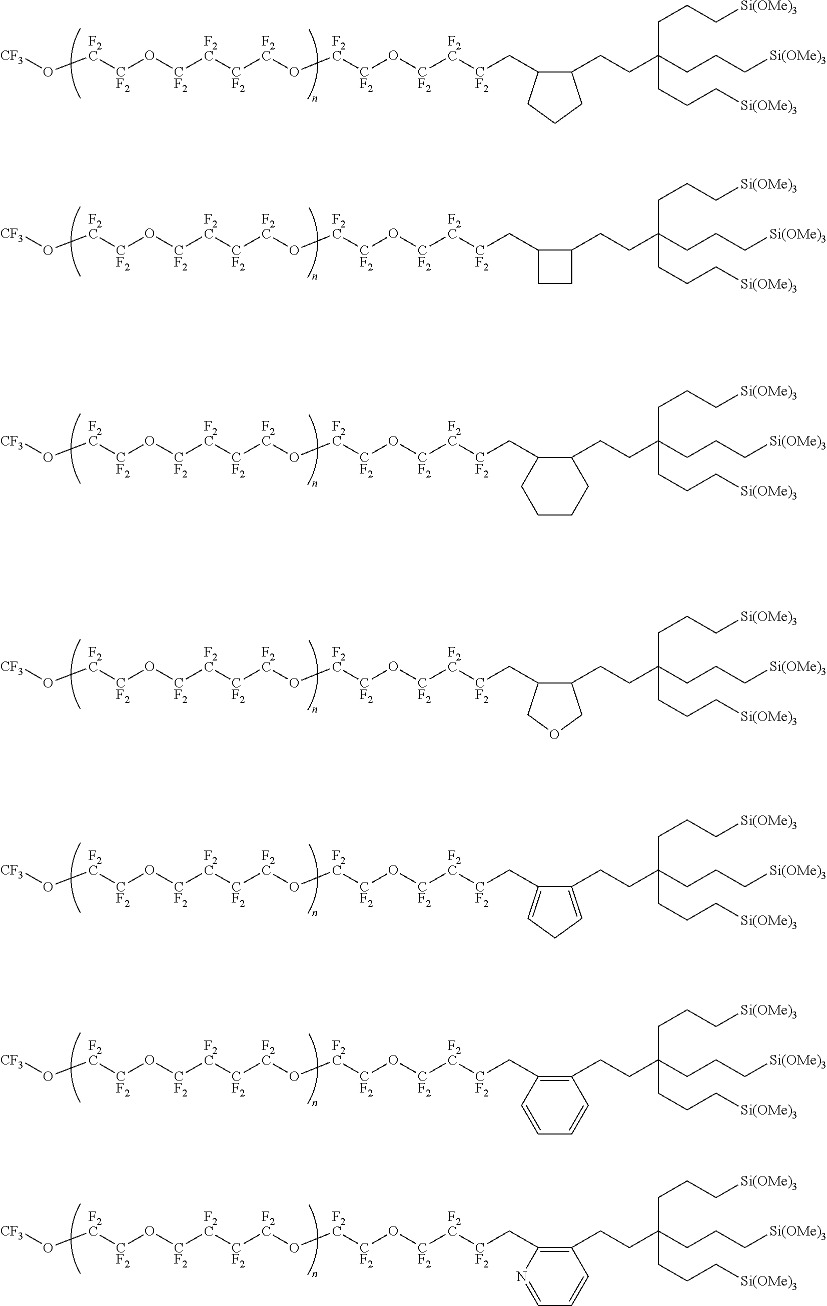

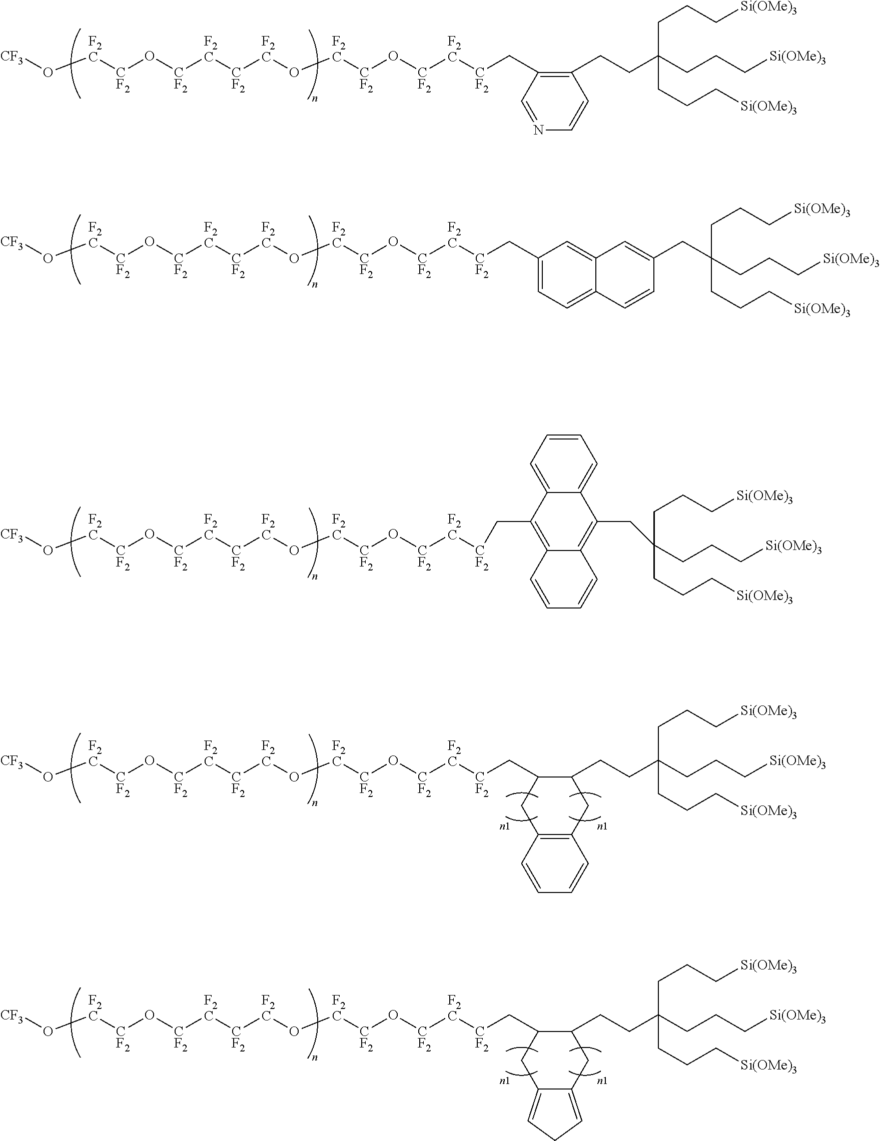

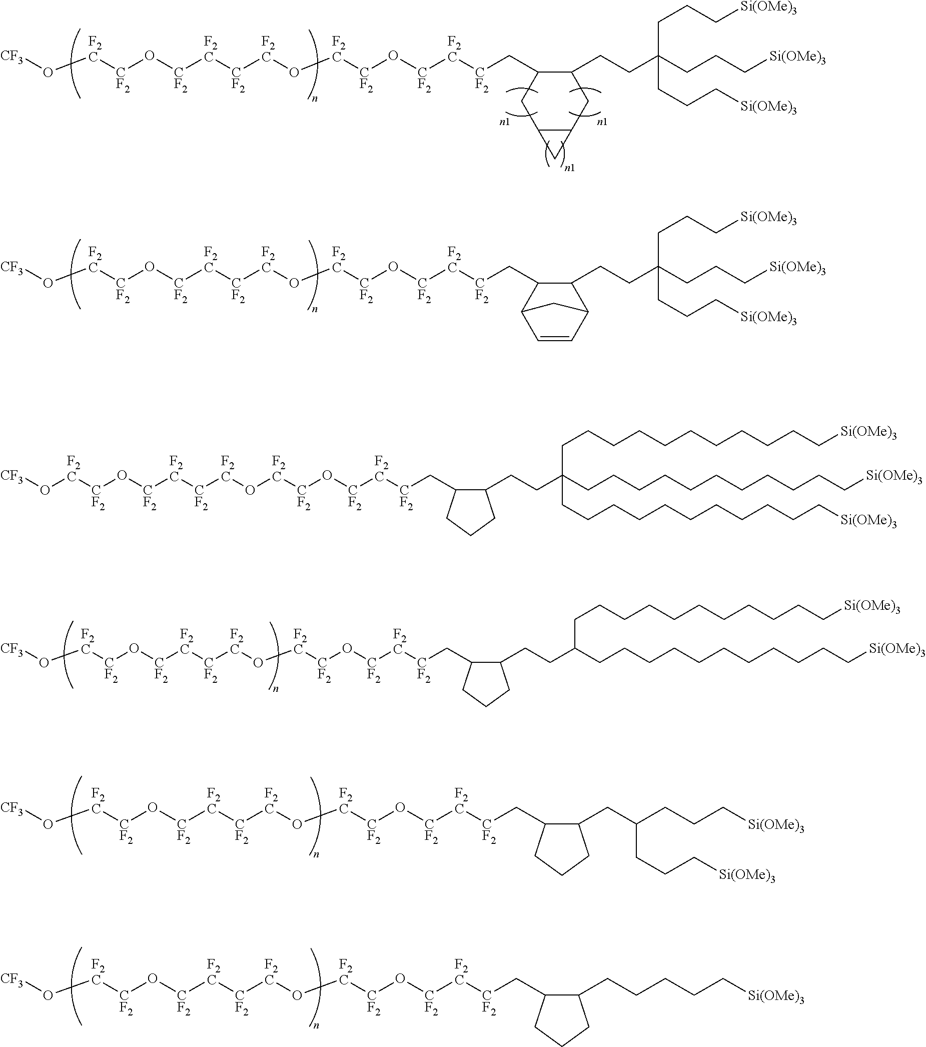

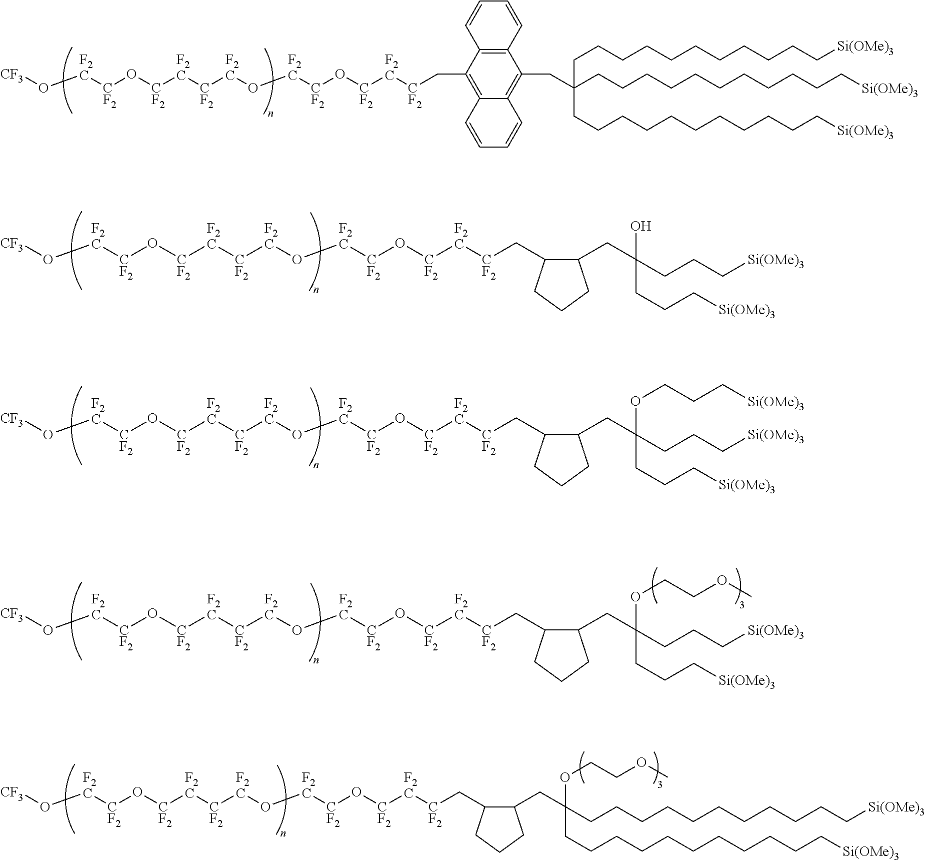

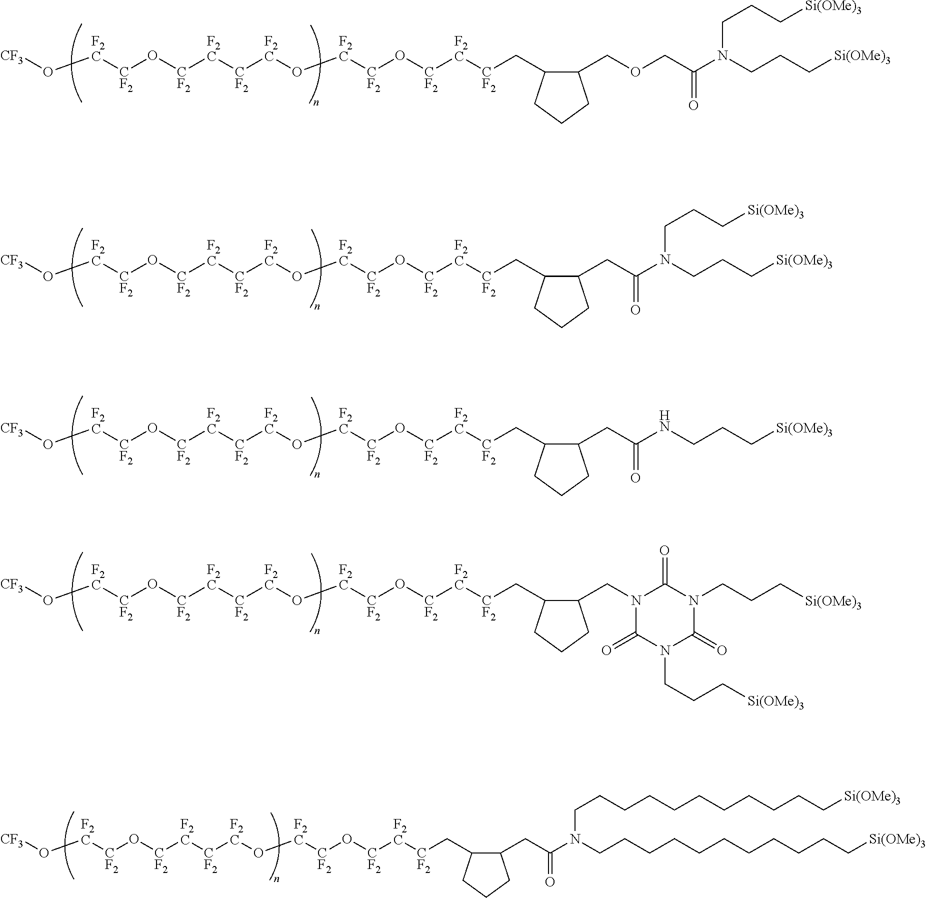

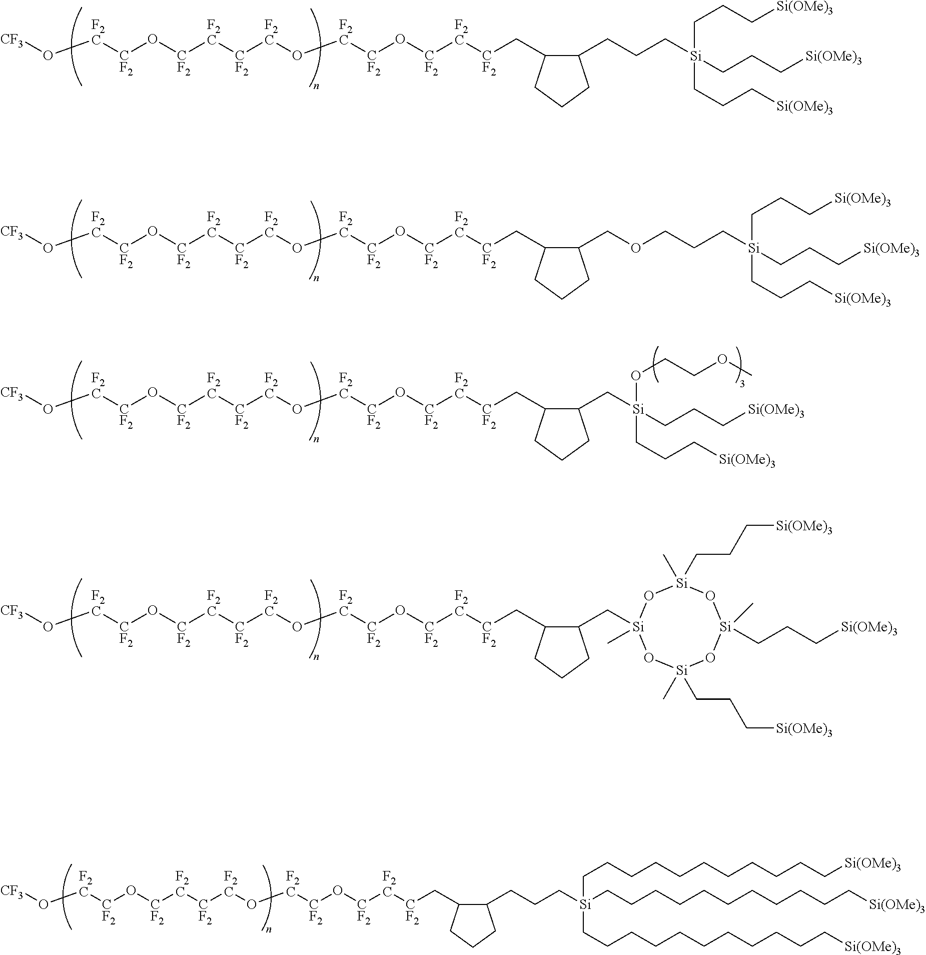

### <Compound 2>

Compound 2 is a compound represented by formula (2):

(T³-R⁹)ₓ₃-L³-R⁸-Q³-R⁷—R^{f}—(OR^{f2})_{y2}—R⁴-Q²-R⁵-L²-(R⁶-T²)ₓ₂ Formula (2)
where each symbol in the formula is as described above.

R^{f} is a fluoroalkylene group having 1 to 6 carbon atoms. The fluoroalkylene group is the same as R^{f1}, and preferred aspects are also the same.

R^{f2} and (OR^{f2})_{y2} correspond to R^{f} and (OR^{f1})_{y1} in compound 1. The structures of R^{f2} and (OR^{f2})_{y2} are each independently the same as those of R^{f} and (OR^{f1})_{y1}, and preferred aspects are also the same.

(T³-R⁹)ₓ₃ and (R⁶-T²)ₓ₂ correspond to (R³-T¹)ₓ₁ in compound 1. The structures of (T³-R⁹)ₓ₃ and (R⁶-T²)ₓ₂ are each independently the same as those of (R³-T¹)ₓ₁, and preferred aspects are also the same.

R⁴ and R¹ correspond to R¹ in compound 1. The structures of R⁴ and R¹ are each independently the same as those of R¹, and preferred aspects are also the same.

Q² and Q¹ correspond to Q¹ in compound 1. The structures of Q² and Q¹ are each independently the same as those of Q¹, and preferred aspects are also the same.

R⁵ and R⁸ correspond to R² in compound 1. The structures of R⁵ and R⁸ are each independently the same as those of R², and preferred aspects are also the same.

L² and L³ correspond to L¹ in compound 1. The structures of L² and L³ are each independently the same as those of L¹, and preferred aspects are also the same.

Specific examples of the compound 2 include the following,

provided that each n is independently an integer of 1 or more.

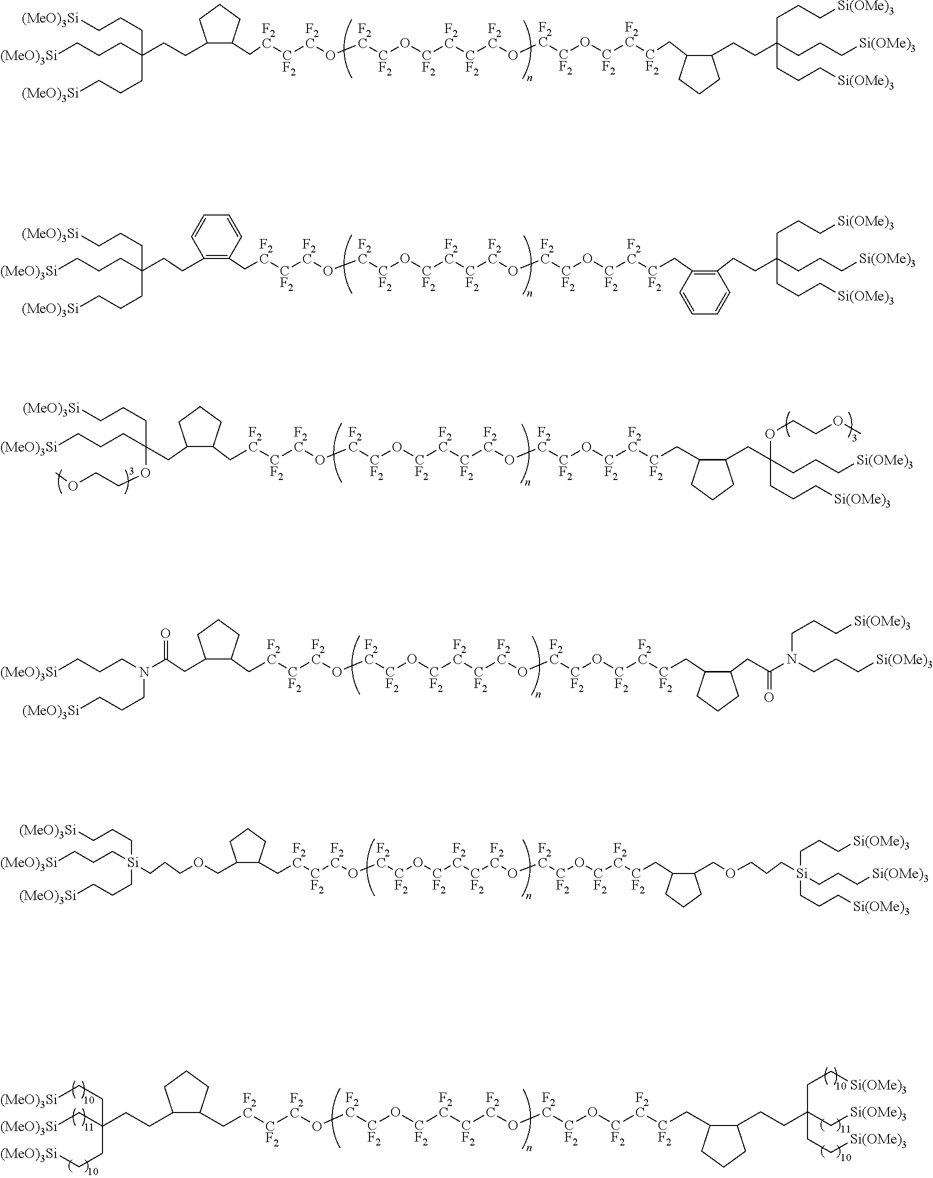

### (Method for Producing Compound 1 and Compound 2)

The method for producing compound 1 and compound 2 is preferably, but is not particularly limited to, a method of subjecting, for example, a compound represented by formula (5) or a compound represented by formula (6) and compound 101 represented by formula (101) to hydrosilylation from the viewpoint of obtaining a high yield.

A¹-(OR^{f1})_{y1}—R¹-Q¹-R²-L¹-(R^{C1}—CH═CH₂)ₓ₁ Formula (5)

(CH₂═CH—R^{C3})ₓ₃-L³-R⁸-Q³-R⁷—R^{f}—(OR^{f2})_{y2}—R⁴-Q²-R⁵-L²-(R^{C2}—CH═CH₂)ₓ₂ Formula (6)

HSiR^{a1}_{z1}R^{a11}_{3-z1} Formula (101)
in which
R^{C1}, R^{C2}, and R^{C3} are each independently an alkylene group which may have an etheric oxygen atom at the terminal on the L¹, L², or L³ side or between carbon-carbon atoms, and when there is a plurality of R^{C1}, R^{C2} or R^{C3}, R^{C1}, R^{C2} or R^{C13} may each independently be the same as or different from each other; and
each of the other symbols is the same as each of the symbols in formula (1) or (2), and preferred aspects are also the same.

Note that R^{C1}—CH═CH₂ corresponds to R³ in formula (1) after the reaction, R^{C1}—CH═CH₂ corresponds to R⁶ in formula (2) after the reaction, and CH₂═CH—R^{C3} corresponds to R⁹ in formula (2) after the reaction.

Compounds 5 and 6 can be produced, for example, by coupling a compound represented by formula (3) or a compound represented by formula (4) with a compound represented by formula (102) in the presence of a transition metal catalyst and a ligand:

A¹-(OR^{f1})_{y1}—R¹-Q¹-R²¹-D¹ Formula (3)

D³-R⁸¹-Q³-R⁷—R^{f}—(OR^{f2})_{y2}—R⁴-Q²-R⁵¹-D² Formula (4)

D¹¹-R²²-L¹-(R^{C1}—CH═CH₂)ₓ₁ Formula (102)
in which
D¹, D², and D³ are each independently a halogen atom;
D¹¹ is an atomic group containing any one atom selected from the group consisting of Mg, Zn, Sn, B, Si, and Al, which is directly bonded to R²²;
R²² is a single bond or an alkylene group;
the other symbols are as described above, provided that when formula (102) is reacted with formula (4), L¹ in formula (102) is comparable to L² or L³, R^{C1} is comparable to R^{C2} or R^{C3}, and x1 is comparable to x2 or x3.

Note that after the reaction, —R²¹—R²²— corresponds to —R²—, —R⁵¹—R²²— corresponds to —R⁵—, and —R⁸¹—R²²— corresponds to —R⁸—.

Examples of the transition metal catalyst include a copper salt such as CuCl₂. Examples of the ligand include a pi ligand in which a carbon-carbon multiple bond is coordinated to a metal atom, such as 1-phenyl-1-propyne.

Compound 102 can be synthesized with reference to, for example, the method in International Patent Publication No. WO 2021/054413.

Compounds 3 and 4 are novel compounds in which a cyclic structure is bonded to at least one end of a fluoropolyether chain. Compounds 3 and 4 are suitable compounds for the production of compounds 1 and 2 above.

A¹-(OR^{f1})_{y1}—R¹-Q¹-R²¹-D¹ Formula (3)

D³-R⁸¹-Q³-R⁷—R^{f}—(OR^{f2})_{y2}—R⁴-Q²-R⁵¹-D² Formula (4)
where each symbol in the formulae is as described,
From the viewpoint of reactivity, the halogen atom in D¹, D², and D³ is preferably any one of a chlorine atom, a bromine atom, or an iodine atom, and particularly preferably an iodine atom.

When R²¹ is a single bond, the present compound has a structure in which Q¹ is directly bonded to D¹.

When R²¹ is a divalent group, R²¹ is, for example, —NR^{N}C(═O)—, —OC(═O)—, —C(═O)—, or an alkylene group.

When R² is an alkylene group, it may have —O—, —S—, —C(═O)NR^{N}—, —NR^{N}C(═O)—, —C(═O)O—, —OC(═O)—, or C(═O)— on the side bonded to Q¹ or between carbon-carbon bonds and —NR^{N}C(═O)—, —OC(═O)—, or C(═O)— at the terminal on the side bonded to D¹.

From the viewpoint of ease of synthesis, R²¹ is preferably an alkylene group, and more preferably a methylene group.

R⁵¹ and R⁸¹ in compound 4 are each independently the same as R²¹ in compound 3, and preferred aspects are also the same.

D¹ is a halogen atom.

From the viewpoint of reactivity, D¹ is preferably any one of a chlorine atom, a bromine atom, or an iodine atom, and particularly preferably an iodine atom.

D² and D³ in compound 4 are each independently the same as D¹ in compound 3, and preferred aspects are also the same.

### (Method for Producing Compound 3 and Compound 4)

Examples of the method for synthesizing compounds 3 and 4 include (I) a method of introducing a reactive group into the end of a fluoropolyether chain and subjecting the reactive group to an addition reaction with a compound having an addition-reactive substituent and a cyclic structure; and (II) a method of subjecting a compound represented by formula (7) or a compound represented by formula (8) and a diene to a radical cyclization reaction in the presence of a radical initiator:

A¹-(OR^{f1})_{y1}-D¹ Formula (7)

D³-R^{f}—(OR^{f2})_{y2}-D² Formula (8)
where each symbol in the formulae is as described above.

Note that compounds 7 and 8 can be produced, for example, by the method described in International Patent Publication No. WO 2019/163282.

Examples of the radical initiator include 2,2-azobis(2-methylbutyronitrile), azo compounds such as azobisisobutyronitrile, and organic peroxides.

Examples of the diene include a compound represented by formula (103) below.

For example, when compounds 103 and 7 are used, compounds 3A and 3B represented by formulae (3A) and (3B) below, respectively, may be obtained as a mixture as reaction products.

Both compounds 3A and 3B can be used as compound 3. Compounds 3A and 3B may be used after being separated and purified, or may be used as a mixture containing two types of compounds 3.

CH₂═CH—R¹⁰³—CH═CH₂ Formula (103)

However, R¹⁰³ is an alkylene group optionally having an etheric oxygen or —NR^{N}—, in which the main chain preferably contains 3 to 6 atoms from the viewpoint of ease of synthesis, for example.

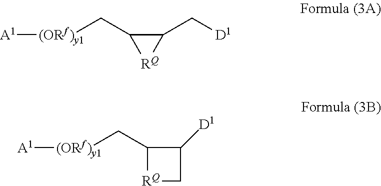

When the group Q1 in compound 3 is an aryl group, compound 3 may be produced by coupling reaction of compound 7 with compound 104 represented by formula (104) in the presence of a suitable transition metal catalyst and a suitable ligand:

A¹-(OR^{f1})_{y1}—R¹-D¹³ Formula (7)

D¹⁴-Q¹-R²¹-D¹ Formula (104)
in which
D¹ is a halogen atom;
D¹³ is an atomic group containing any one atom selected from the group consisting of Mg, Zn, Sn, B, Si, and Al, which is directly bonded to R¹;
D¹⁴ is a halogen atom or a leaving group such as -OTs; and
Ts is a tosyl group.

### [Fluorine-Containing Compound-Containing Composition]

The fluorine-containing compound-containing composition of the present invention (hereinafter also referred to as “the present composition”) contains one or more fluorine-containing ether compounds, which are the present compounds, and a fluorine-containing ether compound other than the present compounds. The present composition may contain, for example, both compound 1 and compound 2 as the present compounds. The present composition may also contain both Compound 1 synthesized from Compound 3A and Compound 1 synthesized from Compound 3B. The present composition does not contain a liquid medium described later.

Examples of other fluorine-containing ether compounds include both unavoidably contained compounds and compounds used in combination according to applications and the like.

Examples of the compounds used in combination with the present compound include known fluorine-containing ether compounds and fluorine-containing oil.

Examples of the fluorine-containing oil include polytetrafluoroethylene (PTFE), ethylene-chlorotrifluoroethylene copolymer (ECTFE), polyvinylidene fluoride (PVDF), polyvinyl fluoride (PVF), and polychiorotrifluoroethylene (PCTFE).

In addition, examples of the known fluorine-containing ether compounds include fluorine-containing ether compounds that are commercially available as surface treating agents. When the present composition contains a known fluorine-containing ether compound, new effects such as supplementing the properties of the present compound may be exhibited.

Examples of the known fluorine-containing ether compounds include those described in the following literatures:
perfluoropolyether-modified aminosilanes described in Japanese Unexamined Patent Application Publication No. H11-029585;
silicon-containing organic fluorine-containing polymers described in Japanese Patent No. 2874715;
organic silicon compounds described in Japanese Unexamined Patent Application Publication No. 2000-144097;
perfluoropolyether-modified aminosilanes described in Japanese Unexamined Patent Application Publication No. 2000-327772;
fluorinated siloxanes described in Japanese Translation of PCT International Application Publication No. 2002-506887;
organic silicon compounds described in Japanese Translation of PCT International Application Publication No. 2008-534696;
fluorinated modified hydrogen-containing polymers described in Japanese Patent No. 4138936;
compounds described in US Patent Publication No. 2010/0129672, International Patent Publication No. WO 2014/126064, and Japanese Unexamined Patent Application Publication No. 2014-070163;
Organosilicon compounds described in International Patent Publication No. WO 2011/060047 and International Patent Publication No. WO 2011/059430;
fluorine-containing organosilane compounds described in International Patent Publication No. WO 2012/064649;
fluorooxyalkylene group-containing polymers described in Japanese Unexamined Patent Application Publication No. 2012-72272;
fluorine-containing ether compounds described in International Patent Publication No. WO 2013/042732, International Patent Publication No. WO 2013/121984, International Patent Publication No. WO 2013/121985, International Patent Publication No. WO 2013/121986, International Patent Publication No. WO 2014/163004, Japanese Unexamined Patent Application Publication No. 2014-080473, International Patent Publication No. WO 2015/087902, International Patent Publication No. WO 2017/038830, International Patent Publication No. WO 2017/038832, and International Patent Publication No. WO 2017/187775;
perfluoro(poly)ether-containing silane compounds described in Japanese Unexamined Patent Application Publication No. 2014-218639, International Patent Publication No. WO 2017/022437, International Patent Publication No. WO 2018/079743, and International Patent Publication No. WO 2018/143433;
fluoropolyether group-containing polymer-modified silanes described in Japanese Unexamined Patent Application Publication No. 2015-199906, Japanese Unexamined Patent Application Publication No. 2016-204656, Japanese Unexamined Patent Application Publication No. 2016-210854, and Japanese Unexamined Patent Application Publication No. 2016-222859; and
Fluorine-containing ether compounds described in International Patent Publication No. WO 2018/216630. International Patent Publication No. WO 2019/039226, International Patent Publication No. WO 2019/039341. International Patent Publication No. WO 2019/039186, International Patent Publication No. WO 2019/044479, Japanese Unexamined Patent Application Publication No. 2019-44158, and International Patent Publication No. WO 2019/163282.

In addition, examples of commercially available products of the fluorine-containing compound include KY-100 series (KY-178, KY-185, KY-195, etc.) manufactured by Shin-Etsu Chemical Co., Ltd.; SURECO AF series such as SURECO (registered trademark) 2101S manufactured by AGC Inc.; and OPTOOL (registered trademark) DSX, OPTOOL (registered trademark) AES, OPTOOL (registered trademark) UF503, and OPTOOL (registered trademark) UD509 manufactured by Daikin Industries, Ltd.

When the present compound is used in combination with a known fluorine-containing ether compound in the present composition, the content ratio is properly adjusted depending upon, for example, the application. The content of the present compound in the present composition is preferably 10 to 90% by mass, more preferably 20 to 80% by mass, even more preferably 25 to 75% by mass. Within the above range, properties of the present compound are sufficiently exhibited and in addition, properties of the fluorine-containing ether compound used in combination can also be sufficiently obtained.

Examples of the unavoidably contained compound include a fluorine-containing ether compound formed as a by-product in the process for producing the present compound (hereinafter sometimes referred to as “by-product fluorine-containing ether compound”).

Examples of the by-product fluorine-containing ether compound include an unreacted fluorine-containing compound (for example, compound 3 or compound 4) and a fluorine-containing ether compound formed through isomerization of some of the allyl groups into an inner olefin accompanying hydrosilylation during the production of the present compound.

When the present composition contains the by-product fluorine-containing ether compound, the by-product fluorine-containing ether compound may be removed by purification but may be contained in the present composition within a range where the properties of the present compound are sufficiently exhibited, whereby the process for purifying the by-product fluorine-containing ether compound can be simplified.

When the known fluorine-containing ether compound is not used in combination, the content of the present compound in the present composition is preferably 60% by mass or more and less than 100% by mass, more preferably 70% by mass or more and less than 100% by mass, particularly preferably 80% by mass or more and less than 100% by mass in the present composition.

The content of the by-product fluorine-containing ether compound is preferably more than 0% by mass and 40% by mass or less, more preferably more than 0% by mass and 30% by mass or less, particularly preferably more than 0% by mass and 20% by mass or less in the present composition.

If the content of the present compound and the content of the by-product fluorine-containing ether compound are within the above ranges, the surface layer is more excellent in initial water/oil repellency, antifriction properties, fingerprint stain removability, light resistance, and chemical resistance.

The unavoidably contained compounds include additives such as an acid catalyst and a basic catalyst that promote hydrolysis and condensation reaction of the hydrolyzable silyl group. Examples of the acid catalyst include hydrochloric acid, nitric acid, acetic acid, sulfuric acid, phosphoric acid, sulfonic acid, methanesulfonic acid, and p-toluenesulfonic acid. Examples of the basic catalyst include sodium hydroxide, potassium hydroxide, and ammonia.

The content of such a component is preferably 0 to 9.999% by mass and particularly preferably 0 to 0.99% by mass in the present composition.

### [Surface Treating Agent]

A surface treating agent containing the present fluorine-containing ether compound (hereinafter also referred to as the present surface treating agent) is suitably used in an application where it is desired to maintain, for a long period of time, a performance (antifriction properties) whereby water/oil repellency is less likely to be lowered even if the surface layer is rubbed repeatedly with fingers and a performance (fingerprint stain removability) whereby a fingerprint adhering to the surface layer can be readily removed by wiping, for example, as a surface treating agent for a member constituting a plane of a touch panel to be touched with fingers, an eyeglass lens, and a display of a wearable terminal.

### [Coating Liquid]

The coating liquid of the present invention (hereinafter also referred to as the present coating liquid) contains the present fluorine-containing ether compound and a liquid medium. The present coating liquid may be a liquid, may be a solution, or may be a dispersion.

The present coating liquid may contain the present fluorine-containing ether compound and may also contain impurities such as by-products generated in the production process of the present fluorine-containing ether compound.

The concentration of the present fluorine-containing ether compound is preferably 0.001 to 40% by mass, more preferably 0.01 to 20% by mass, and even more preferably 0.1 to 10% by mass in the present coating liquid.

The liquid medium is preferably an organic solvent. The organic solvent may be a fluorine-based organic solvent and non-fluorine-based organic solvent, or may contain both solvents.

Examples of the fluorine-based organic solvent include fluorinated alkanes, fluorinated aromatic compounds, fluoroalkyl ethers, fluorinated alkylamines, and fluoroalcohols.

The fluorinated alkane is preferably a compound having 4 to 8 carbon atoms. Examples of the commercially available product include C₆F₁₃H (ASAHIKLIN (registered trademark) AC-2000 manufactured by AGC Inc.), C₆F₁₃C₂H₅(ASAHIKLIN (registered trademark) AC-6000 manufactured by AGC Inc.), and C₂F₅CHFCHFCF₃ (Vertrel (registered trademark) XF manufactured by the Chemours Company).

Examples of the fluorinated aromatic compound include hexafluorobenzene, trifluoromethylbenzene, perfluorotoluene, and bis(trifluoromethyl)benzene.

The fluoroalkyl ether is preferably a compound having 4 to 12 carbon atoms. Examples of the commercially available product include CF₃CH₂OCF₂CF₂H (ASAHIKLIN (registered trademark) AE-3000 manufactured by AGC Inc.), C₄F₉OCH₃ (Novec (registered trademark) 7100 manufactured by 3M), C₄F₉OC₂H₅ (Novec (registered trademark) 7200 manufactured by 3M), and C₂F₅CF(OCH₃)C₃F₇(Novec (registered trademark) 7300 manufactured by 3M).

Examples of the fluorinated alkylamine include perfluorotripropylamine and perfluorotributylamine.

Examples of the fluoroalcohol include 2,2,3,3-tetrafluoropropanol, 2,2,2-trifluoroethanol, and hexafluoroisopropanol.

The non-fluorine-based organic solvent is preferably a compound consisting only of a hydrogen atom and a carbon atom and a compound consisting only of a hydrogen atom, a carbon atom, and an oxygen atom, and examples thereof include a hydrocarbon-based organic solvent, an alcohol-based organic solvent, a ketone-based organic solvent, an ether-based organic solvent, and an ester-based organic solvent.

The present coating liquid preferably contains 75 to 99.999% by mass, preferably 85 to 99.99% by mass, and particularly preferably 90 to 99.9% by mass of the liquid medium.

The present coating liquid may contain other components in addition to the present fluorine-containing ether compound and the liquid medium as long as the effects of the present invention are not impaired.

Examples of other components include known additives such as an acid catalyst and a basic catalyst that promote hydrolysis and condensation reaction of a hydrolyzable silyl group.

The content of other components in the present coating liquid is preferably 10% by mass or less, and more preferably 1% by mass or less.

The total concentration of the present fluorine-containing ether compound and other components in the present coating liquid (hereinafter also referred to as a solid content concentration) is preferably 0.001 to 40% by mass, more preferably 0.01 to 20% by mass, even more preferably 0.01 to 10% by mass, and particularly preferably 0.01 to 1% by mass.

The solid content concentration of the coating liquid is a value calculated from the mass of the coating liquid before heating and the mass after heating in a convection dryer at 120° C. for 4 hours.

### [Article]

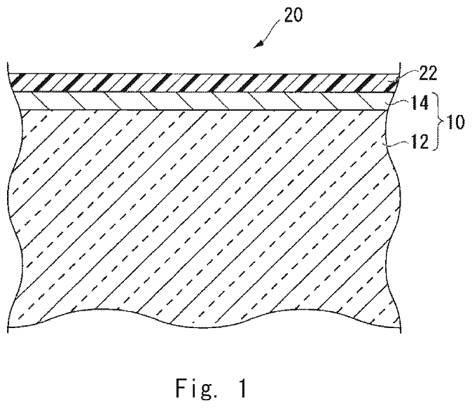

FIG. 1 is a schematic cross-sectional view illustrating one example of an article of the present invention. A first article of the present invention is an article 20 having a substrate 12, an underlying layer 14, and a surface layer 22 in this order, in which the underlying layer 14 contains an oxide containing silicon while the surface layer 22 contains a condensate of the present composition.

The material and shape of the substrate 12 in the first article may be appropriately selected according to the application of the present article 20 and the like. Examples of the material of the substrate 12 include glass, resin, sapphire, metal, ceramic, stone, and composite materials thereof. The glass may be chemically strengthened. In particular, examples of the substrate 12 required to have water/oil repellency include a substrate for a touch panel, a substrate for a display, and a substrate constituting a housing of electronic equipment. The substrate for a touch panel and the substrate for a display have translucency. The expression “having translucency” means that the normal incidence type visible light transmittance according to JIS R3106: 1998 (ISO 9050: 1990) is 25% or more. The material of the substrate for a touch panel is preferably glass or a transparent resin.

The substrate 12 may be obtained by subjecting the surface on which the underlying layer 14 is provided to a surface treatment such as a corona discharge treatment, a plasma treatment, or a plasma graft polymerization treatment. The surface-treated surface has further excellent adhesiveness between the substrate 12 and the underlying layer 14, and as a result, the abrasion resistance properties of the surface layer 22 is further improved. The surface treatment is preferably a corona discharge treatment or a plasma treatment from the viewpoint of further excellent abrasion resistance properties of the surface layer 22.

The underlying layer 14 is a layer containing an oxide containing at least silicon, and may further contain other elements. When the underlying layer 14 contains silicon oxide, T¹ of the present composition is dehydrated and condensed to form a Si—O—Si bond between the underlying layers 14, and the surface layer 22 having excellent abrasion durability is formed.

The content of silicon oxide in the underlying layer 14 may be 65% by mass or more, and is preferably 80% by mass or more, more preferably 85% by mass or more, and even more preferably 90% by mass or more. When the content of silicon oxide is equal to or more than the lower limit value of the above range, a Si—O—Si bond is sufficiently formed in the underlying layer 14, and the mechanical characteristics of the underlying layer 14 are sufficiently secured. The content of silicon oxide is the remainder obtained by subtracting the sum of the total contents of other elements (in the case of oxides, the amount in terms of oxides) from the mass of the underlying layer 14.

From the viewpoint of durability of the surface layer 22, the oxide in the underlying layer 14 preferably further contains one or more elements selected from an alkali metal element, an alkaline earth metal element, a platinum group element, boron, aluminum, phosphorus, titanium, zirconium, iron, nickel, chromium, molybdenum, and tungsten. By containing these elements, the bond between the underlying layer 14 and the present composition is strengthened, and the abrasion resistance is thus improved.

When the underlying layer 14 contains one or more selected from iron, nickel, and chromium, the total content thereof is preferably 10 to 1,100 ppm by mass, more preferably 50 to 1,100 ppm by mass, even more preferably 50 to 500 ppm by mass, and particularly preferably 50 to 250 ppm by mass in terms of a proportion with respect to silicon oxide.

When the underlying layer 14 contains one or more selected from aluminum and zirconium, the total content thereof is preferably 10 to 2,500 ppm by mass, more preferably 15 to 2,000 ppm by mass, and even more preferably 20 to 1,000 ppm by mass.

When the underlying layer 14 contains an alkali metal element, the total content thereof is preferably 0.05 to 15% by mass, more preferably 0.1 to 13% by mass, and even more preferably 1.0 to 10% by mass. Note that examples of the alkali metal element include lithium, sodium, potassium, rubidium, and cesium.

When the underlying layer 14 contains a platinum group element, the total content thereof is preferably 0.02 ppm by mass or more and 800 ppm by mass or less, more preferably 0.04 ppm by mass or more and 600 ppm by mass or less, and even more preferably 0.7 ppm by mass or more and 200 ppm by mass or less. Note that examples of the platinum group element include platinum, rhodium, ruthenium, palladium, osmium, and iridium.

When the underlying layer 14 contains one or more selected from boron and phosphorus, the total content thereof is preferably 0.003 to 9, more preferably 0.003 to 2, and even more preferably 0.003 to 0.5 as the ratio of the total molar concentration of boron and phosphorus to the molar concentration of silicon from the viewpoint of the abrasion resistance properties of the surface layer 22.

When the underlying layer 14 contains an alkaline earth metal element, the total content thereof is preferably 0.005 to 5, more preferably 0.005 to 2, and even more preferably 0.007 to 2 as the ratio of the total molar concentration of the alkaline earth metal element to the molar concentration of silicon from the viewpoint of the abrasion resistance properties of the surface layer 22. Note that examples of the alkaline earth metal element include lithium, sodium, potassium, rubidium, and cesium.

From the viewpoint of improving the adhesiveness of the present composition and improving the water/oil repellency and abrasion resistance properties of the article 20, the underlying layer 14 is preferably a silicon oxide layer containing an alkali metal atom. In particular, in the silicon oxide layer, the mean value of the concentrations of alkali metal atoms in the region where the depth from the surface in contact with the surface layer 22 is 0.1 to 0.3 nm is preferably 2.0×10¹⁹ atoms/cm³ or more. On the other hand, from the viewpoint of sufficiently securing the mechanical characteristics of the silicon oxide layer, the mean value of the concentrations of the alkali metal atoms is preferably 4.0×10²² atoms/cm³ or less.

The thickness of the underlying layer 14 is preferably 1 to 200 nm, and particularly preferably 2 to 20 nm. When the thickness of the underlying layer 14 is equal to or more than the lower limit value of the above range, the effect of improving the adhesiveness by the underlying layer 14 tends to be sufficiently obtained. When the thickness of the underlying layer 14 is equal to or less than the upper limit value of the above range, the underlying layer 14 itself has enhanced abrasion resistance properties. Examples of a method of measuring the thickness of the underlying layer 14 include a method by observing a cross-section of the underlying layer 14 with an electron microscope (SEM, TEM, etc.), and a method using, for example, an optical interference film thickness meter, a spectroscopic ellipsometer, or a step profiler.

Examples of the method of forming the underlying layer 14 include a method of depositing a vapor deposition material having a desired composition of the underlying layer 14 on the surface of the substrate 12.

An example of the vapor deposition method is a vacuum deposition method. The vacuum deposition method is a method of evaporating a vapor deposition material in a vacuum tank to attach it to the surface of the substrate 12.

The temperature during vapor deposition (for example, temperature of the boat on which the vapor deposition material is installed when a vacuum deposition apparatus is used) is preferably 100 to 3,000° C., and particularly preferably 500 to 3,000° C. The pressure during vapor deposition (for example, absolute pressure in the tank in which the vapor deposition material is installed when a vacuum deposition apparatus is used) is preferably 1 Pa or less, and particularly preferably 0.1 Pa or less.

When the underlying layer 14 is formed using a vapor deposition material, one vapor deposition material may be used, or two or more vapor deposition materials containing different elements may be used.

Examples of the method of evaporating the vapor deposition material include a resistance heating method of melting and evaporating the vapor deposition material on a resistance heating boat made of a high melting point metal, and an electron gun method of irradiating the vapor deposition material with an electron beam and directly heating the vapor deposition material to melt the surface and evaporate the vapor deposition material. The method of evaporating the vapor deposition material is preferably the electron gun method because a high melting point substance can also be evaporated since the vapor deposition material can be locally heated, and there is no concern about reaction with a container or mixing of impurities since a part not hit by an electron beam is at a low temperature. The vapor deposition material used in the electron gun method is preferably a molten granular material or a sintered body from the viewpoint of being less likely to scatter even when an air flow is generated.

The surface layer 22 on the underlying layer 14 contains a condensate of the present compound contained in the present composition. The condensate of the present compound includes a compound having a Si—O—Si bond formed by an intermolecular condensation reaction of a silanol group (Si—OH) which is formed by a hydrolysis reaction of the hydrolyzable silyl group in the present compound contained in the present composition; and a compound having a Si—O—Si bond formed by a condensation reaction of the silanol group in the present compound with a silanol group or a Si-OM group (where M is an alkali metal element) on the surface of the underlying layer 14. In addition, the surface layer 22 may contain a condensate of a fluorine-containing compound other than the compounds contained in the present composition. In other words, the surface layer 22 contains the fluorine-containing compound having a reactive silyl group in a state where a part or all of the reactive silyl group of the fluorine-containing compound undergoes a condensation reaction.

The thickness of the surface layer 22 is preferably 1 to 100 nm, and particularly preferably 1 to 50 nm. When the thickness of the surface layer 22 is equal to or more than the lower limit value of the above range, the effect of the surface layer 22 can be sufficiently obtained. When the thickness of the surface layer 22 is equal to or less than the upper limit value of the above range, the utilization efficiency is high.

The thickness of the surface layer 22 is a thickness obtained by an X-ray diffractometer for thin film analysis. The thickness of the surface layer 22 can be calculated from the vibration period of the interference pattern by obtaining the interference pattern of the reflected X-ray by the X-ray reflectance method using the X-ray diffractometer for thin film analysis.

A second article of the present invention is the article 20 having an underlying layer-attached substrate 10 and the surface layer 22 in this order, in which the underlying layer-attached substrate 10 contains an oxide containing silicon while the surface layer 22 contains a condensate of the present composition.

The second article has excellent abrasion durability of the surface layer 22 even when the surface layer 22 is directly formed on the underlying layer-attached substrate 10 since the underlying layer-attached substrate 10 has the composition of the underlying layer 14 in the first article.

The material of the underlying layer-attached substrate 10 in the second article may be any material having the composition of the underlying layer 14, and may be, for example, a glass substrate. The details of the material of the underlying layer-attached substrate 10 are the same as the materials of the substrate 12 and the underlying layer 14, and thus the description thereof is omitted here. Since the configuration of the surface layer 22 is also the same as that of the first article, the description thereof is omitted here.

### [Method for Producing Article]

The method for producing an article according to the present invention is a method of forming a surface layer by a dry coating method or a wet coating method using the fluorine-containing compound, the surface treating agent, or the coating liquid.

The present fluorine-containing ether compound and the present surface treating agent can be used as they are in a dry coating method. In addition, the present composition and the present surface treating agent are suitable for forming a surface layer excellent in adhesion by a dry coating method. Examples of the dry coating method include techniques such as vacuum deposition, CVD, and sputtering. The vacuum deposition method can be suitably used from the viewpoint of suppressing decomposition of the present composition and convenience of the apparatus.

For vacuum deposition, a pellet-like substance that supports the present composition on a metal porous body made of a metal material such as iron or steel may be used. The pellet-like substance that supports the present composition can be produced by impregnating the metal porous body with a solution of the present composition and drying the solution to remove the liquid medium. The present coating liquid can be used as the solution of the present composition.

The present coating liquid can be suitably used in a wet coating method. Examples of the wet coating method include a spin coating method, a wipe coating method, a spray coating method, a squeegee coating method, a dip coating method, a die coating method, an inkjet method, a flow coating method, a roll coating method, a casting method, a Langmuir-Blodgett method, and a gravure coating method.

In order to improve antifriction properties of the surface layer, an operation for promoting the reaction between the present composition and the substrate may be performed, if necessary. Examples of the operation include heating, humidification, and light irradiation.

For example, a substrate on which the surface layer is formed can be heated in the atmosphere having moisture to promote reactions such as a hydrolysis reaction of a hydrolyzable group, a reaction of a hydroxyl group or the like on the surface of the substrate with a silanol group, and generation of a siloxane bond by a condensation reaction of a silanol group.

After the surface treatment, the compound in the surface layer, which is a compound that is not chemically bonded to another compound or the substrate, may be removed, if necessary. Specific examples of the method include a method of pouring a solvent on the surface layer and a method of wiping the surface layer with a cloth soaked with the solvent.

The present invention is described in more detail below with reference to Examples, but the present invention is not limited to these Examples. Hereinafter. “%” is “% by mass” unless otherwise specified. Note that Examples 1 to 5 are Examples, and Examples 6 and 7 are Comparative Examples.

### Example 1

### Synthesis Example 1-1

Compound 1-1 was obtained according to the synthetic method described in Example 2-2 of International Patent Publication No. WO 2019/163282.

CF₃—O—(CF₂CF₂O—CF₂CF₂CF₂CF₂O)ₙ₂CF₂CF₂O—CF₂CF₂CF₂—I Formula 7-1

However, the mean value of the repeating unit n2 is 13.

### Synthesis Example 1-2

Compound 1-2 was obtained according to the synthetic method described in Example 2 of International Patent Publication No. WO 2021/054413.

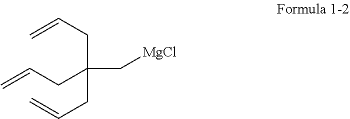

### Synthesis Example 1-3

Into a 50 mL recovery flask, 5 g of compound 1-1 obtained in Synthesis Example 1-1, 0.36 g of diallyl ether, 0.23 g of 2,2-azobis(2-methylbutylonitrile), and 7.2 g of AC-6000 were put, followed by stirring at 80° C. for 3 hours. The temperature in the recovery flask was adjusted to 25° C., and acetone was added thereto, followed by liquid separation. The lower phase was taken, and the solvent was then removed. The resulting crude product was purified by silica gel column chromatography to give 2.4 g of compound 1-3.

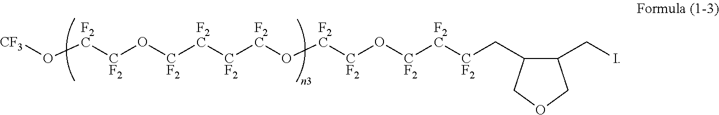

NMR spectrum of compound 3-1

¹H-NMR (400 MHz, Chloroform-d) δ (ppm): 4.1-4.0 (2H), 3.8-3.6 (2H), 3.0-2.7 (2H), 2.6-2.3 (2H), 2.3-2.1 (2H)

¹⁹H-NMR (376 MHz, Chloroform-d) δ (ppm): −55.2 (3F), −82.3 (54F), −87.8 (54F), −89.9 (2F), −111.0-−114.9 (2F), −124.8 (52F), −125.4 (2F)

Mean value of n3: 13.

### Synthesis Example 1-4

Into a 20 mL recovery flask, 2 g of compound 1-3 obtained in Synthesis Example 1-3, 4.9 mg of 1-phenyl-1-propyne, 2.8 mg of CuCl₂, 4 g of AE-3000 4 g, and 0.26 g of compound 1-2 obtained in Synthesis Example 1-2 were put, followed by stirring at 40° C. for 20 hours. The temperature in the recovery flask was adjusted to 25° C., hydrochloric acid was added thereto, followed by liquid separation, and the organic layer was collected. The solvent was then distilled off. The resulting crude product was purified by a silica gel column to give 1.3 g of compound 1-4.

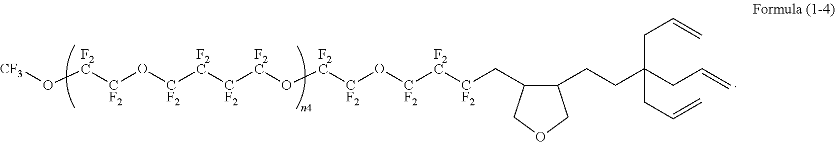

NMR spectrum of compound 1-4

¹H-NMR (400 MHz, Chloroform-d) δ (ppm): 5.9-5.7 (3H), 5.1-4.9 (6H), 4.1-4.0 (2H), 3.8-3.6 (2H), 2.5-1.1 (14H)

¹⁹H-NMR (376 MHz, Chloroform-d) δ (ppm): −55.2 (3F), −82.3 (54F), −87.8 (54F), −89.9 (2F), −110.7-−114.9 (2F), −124.8 (52F), −125.4 (2F)

Mean value of n4: 13.

### Synthesis Example 1-5

Into a 10 mL recovery flask, 1 g of compound 1-4 obtained in Synthesis Example 1-4, 0.11 g of trimethoxysilane, 1.3 mg of aniline, 1 g of AC-6000, and 3.6 mg of platinum/1,3-divinyl-1,1,3,3-tetramethyldisiloxane complex were put, followed by stirring at 40° C. The solvent was distilled off under reduced pressure to give 1.1 g of compound (I).

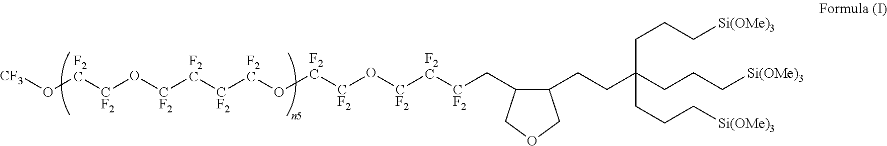

NMR spectrum of compound (I)

¹H-NMR (400 MHz, Chloroform-d) δ (ppm): 4.1-4.0 (2H), 3.8-3.6 (2H), 3.6 (27H), 2.6-0.8 (20H), 0.6 (6H)

¹⁹H-NMR (376 MHz, Chloroform-d) δ (ppm): −55.2 (3F), −82.3 (54F), −87.8 (54F), −89.9 (2F), −110.5-−114.7 (2F), −124.8 (52F), −125.4 (2F)

Mean value of n5: 13.

### Example 2

### Synthesis Example 2-1

Except that diallyl ether was changed to 0.21 g of 1, 6-heptadiene in Synthesis Example 1-3, 4.2 g of compound 2-1 was obtained in the same manner as in Synthesis Example 1-3.

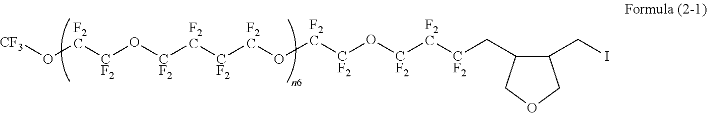

NMR spectrum of compound 2-1

¹H-NMR (400 MHz, Chloroform-d) δ (ppm): 3.5-3.0 (2H), 2.6-1.3 (10H)

¹⁹H-NMR (376 MHz, Chloroform-d) δ (ppm): −55.2 (3F), −82.3 (54F), −87.8 (54F), −89.9 (2F), −111.0-−114.9 (2F), −124.8 (52F), −125.4 (2F)

Mean value of n6: 13.

### Synthesis Example 2-2

Except that compound 1-3 was changed to compound 2-1 in Synthesis Example 1-4, 1.6 g of compound 2-2 was obtained in the same manner as in Synthesis Example 1-4.

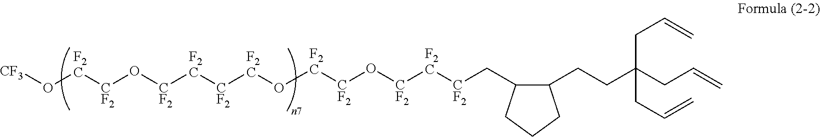

NMR spectrum of compound 2-2

¹H-NMR (400 MHz, Chloroform-d) δ (ppm): 5.9-5.7 (3H), 5.1-4.9 (6H), 2.5-1.1 (20H)

¹⁹H-NMR (376 MHz, Chloroform-d) δ (ppm): −55.2 (3F), −82.3 (54F), −87.8 (54F), −89.9 (2F), −110.7-−114.9 (2F), −124.8 (52F), −125.4 (2F)

Mean value of n7: 13.

### Synthesis Example 2-3

Except that compound 1-4 was changed to compound 2-2 in Synthesis Example 1-5, 1.1 g of compound (II) was obtained in the same manner as in Synthesis Example 1-5.

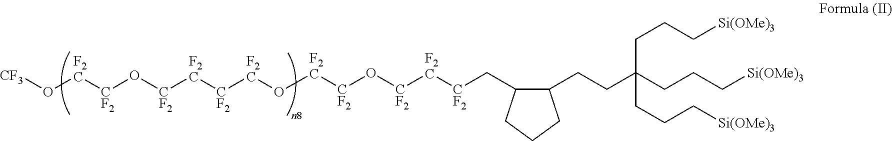

NMR spectrum of compound (II)

¹H-NMR (400 MHz, Chloroform-d) δ (ppm): 3.6 (27H), 2.6-0.8 (26H), 0.6 (6H)

¹⁹H-NMR (376 MHz, Chloroform-d) δ (ppm): −55.2 (3F), −82.3 (54F), −87.8 (54F), −89.9 (2F), −110.5-−114.7 (2F), −124.8 (52F), −125.4 (2F)

Mean value of n8: 13.

### Example 3

### Synthesis Example 3-1

Except that diallyl ether was changed to 0.28 g of 1, 5-hexadiene in Synthesis Example 1-3, 2.6 g of compound 3-1 was obtained in the same manner as in Synthesis Example 1-3.

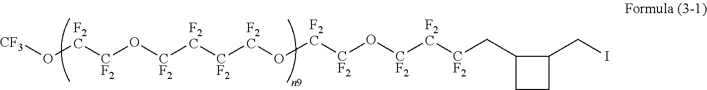

NMR spectrum of compound 3-1

¹H-NMR (400 MHz, Chloroform-d) δ (ppm): 3.2-2.7 (2H), 2.5-1.9 (8H)

¹⁹H-NMR (376 MHz, Chloroform-d) δ (ppm): −55.2 (3F), −82.3 (54F), −87.8 (54F), −89.9 (2F), −110.4-−114.9 (2F), −124.8 (52F), −125.4 (2F)

Mean value of n9: 13.

### Synthesis Example 3-2

Except that compound 1-3 was changed to compound 3-1 in Synthesis Example 1-4, 1.4 g of compound 3-2 was obtained in the same manner as in Synthesis Example 1-4.

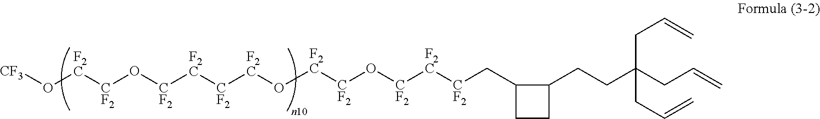

NMR spectrum of compound 5-3

¹H-NMR (400 MHz, Chloroform-d) δ (ppm): 5.9-5.7 (3H), 5.1-4.9 (6H), 2.5-1.1 (18H)

¹⁹H-NMR (376 MHz, Chloroform-d) δ (ppm): −55.2 (3F), −82.3 (54F), −87.8 (54F), −89.9 (2F), −110.2-−114.9 (2F), −124.8 (52F), −125.4 (2F)

Mean value of n10: 13.

### Synthesis Example 3-3

Except that compound 1-4 was changed to compound 3-2 in Synthesis Example 1-5, 1.1 g of compound (III) was obtained in the same manner as in Synthesis Example 1-5.

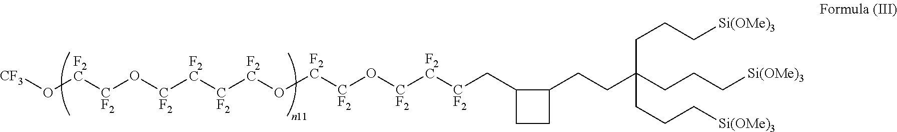

NMR spectrum of compound (III)

¹H-NMR (400 MHz, Chloroform-d) δ (ppm): 3.6 (27H), 2.6-0.8 (24H), 0.6 (6H)

¹⁹H-NMR (376 MHz, Chloroform-d) δ (ppm): −55.2 (3F), −82.3 (54F), −87.8 (54F), −89.9 (2F), −110.1-−114.6 (2F), −124.8 (52F), −125.4 (2F).

Mean value of n11: 13.

### Example 4

### Synthesis Example 4-1

Except that diallyl ether was changed to 0.36 g of 1,7-octadiene in Synthesis Example 1-3, 2.7 g of compound 4-1 was obtained in the same manner as in Synthesis Example 1-3.

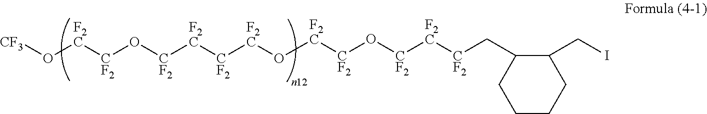

NMR spectrum of compound 4-1

¹H-NMR (400 MHz, Chloroform-d) δ (ppm): 3.1-2.7 (2H), 2.5-1.2 (12H)

¹⁹H-NMR (376 MHz, Chloroform-d) δ (ppm): −55.2 (3F), −82.3 (54F), −87.8 (54F), −89.9 (2F), −110.6-−114.9 (2F), −124.8 (52F), −125.4 (2F)

Mean value of n12: 13.

### Synthesis Example 4-2

Except that compound 1-3 was changed to compound 4-1 in Synthesis Example 1-4, 1.3 g of compound 4-2 was obtained in the same manner as in Synthesis Example 1-4.

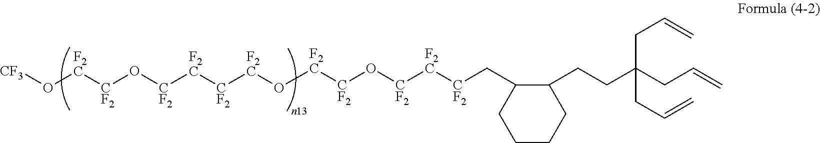

NMR spectrum of compound 4-2

¹H-NMR (400 MHz, Chloroform-d) δ (ppm): 5.9-5.7 (3H), 5.1-4.9 (6H), 2.5-1.1 (22H).

¹⁹H-NMR (376 MHz, Chloroform-d) δ (ppm): −55.2 (3F), −82.3 (54F), −87.8 (54F), −89.9 (2F), −110.4-−114.9 (2F), −124.8 (52F), −125.4 (2F)

Mean value of n13: 13.

### Synthesis Example 4-3

Except that compound 1-4 was changed to compound 4-2 in Synthesis Example 1-5, 1.0 g of compound (IV) was obtained in the same manner as in Synthesis Example 1-5.

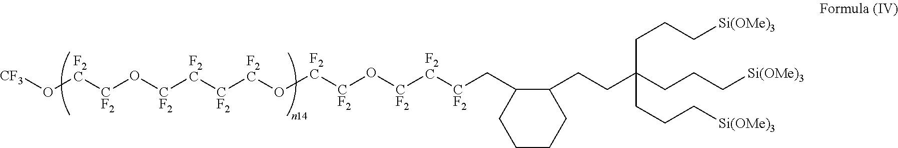

NMR spectrum of compound (IV)

¹H-NMR (400 MHz, Chloroform-d) δ (ppm): 3.6 (27H), 2.6-0.8 (28H), 0.6 (6H)

¹⁹H-NMR (376 MHz, Chloroform-d) δ (ppm): −55.2 (3F), −82.3 (54F), −87.8 (54F), −89.9 (2F), −110.2-−114.6 (2F), −124.8 (52F), −125.4 (2F)

Mean value of n14: 13.

### Example 51

Compound (II) and compound (III) above were mixed at a mass ratio of 50:50 to give a composition of Example 5.

### Example 61

Compound (VI) was obtained according to the synthetic method described in Examples of Japanese Unexamined Patent Application Publication No. 2014-218639.

However, the mean value of n15 was 13.

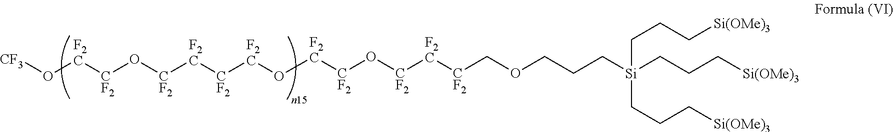

### Example 7

The following (VII) was obtained according to the synthetic method described in Examples of International Patent Publication No. WO 2017/038830.

However, the mean value of n16 was 13.

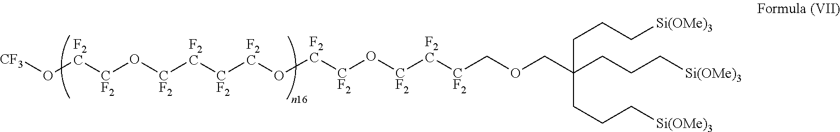

### [Production and Evaluation of Article]

A substrate was surface-treated using the composition and compound obtained by the above production method to obtain an article. As the surface treatment method, in each Example, the following dry coating method and wet coating method were each employed. The substrate used was chemically tempered glass. The obtained article was evaluated by the following method. The results are shown in Table.

### [Dry Coating Method]

Dry coating was conducted by using a vacuum deposition apparatus (manufactured by ULVAC Co., VTR 350M) (vacuum deposition method). 0.5 g of each compound was filled in a boat made of molybdenum in the vacuum deposition apparatus, and inside of the vacuum deposition apparatus was evacuated of air to a level of 1×10⁻³ Pa or less. The boat on which the compound was placed was heated at a temperature raising rate of 10° C./min or less, and at the time when the vapor deposition rate by a quartz oscillator film thickness meter exceeded 1 nm/sec, the shutter was opened to initiate film deposition on the surface of a substrate.

When the film thickness became about 50 nm, the shutter was closed to terminate film deposition on the surface of the substrate. The substrate, on which the compound was deposited, was subjected to heat treatment at 200° C. for 30 minutes, followed by washing with dichloropentafluoropropane (manufactured by AGC Inc., AK-225) to obtain an article having a surface layer on the surface of the substrate.

### [Wet Coating Method]

Each compound was mixed with C₄F₉OC₂H₅ (manufactured by 3M, Novec (registered trademark) 7200) as a medium to prepare a coating liquid having a solid content concentration of 0.05%. A substrate was dipped in the coating liquid, allowed to stand for 30 minutes, and then taken out (dip coating method).

The coating film was dried at 200° C. for 30 minutes and washed with AK-225, to give an article having a surface layer on the surface of the substrate.

### (Evaluation Methods)

### <Method for Measuring Contact Angle>

The contact angle of about 2 μL of distilled water or n-hexadecane placed on the surface of the surface layer, was measured by using a contact angle measuring apparatus (manufactured by Kyowa Interface Science Co., Ltd., DM-500). Measurements were conducted at five different points on the surface of the surface layer, and the mean value was calculated. For the calculation of the contact angle, a 2θ method was employed.

### <Initial Contact Angle>

With respect to the surface layer, the initial water contact angle and n-hexadecane contact angle were measured by the measuring method described above. The evaluation criteria were as follows:

A (excellent): 115 degrees or more.

B (good): 110 degrees or more and less than 115 degrees.

C (acceptable): 100 degrees or more and less than 110 degrees.

D (poor); less than 100 degrees.

### <Antifriction Property (Steel Wool)>

With respect to the surface layer, in accordance with JIS L0849: 2013 (ISO 105-X12: 2001), steel wool Bon Star (#0000) was reciprocated 10,000 times under a pressure of 98.07 kPa at a speed of 320 cm/min by using a reciprocating traverse testing machine (manufactured by KNT Co.). The water contact angle was then measured by the method above. The smaller the decrease in water repellency (water contact angle) after the friction, the smaller the decrease in performance due to friction, and the better the antifriction properties. The evaluation criteria were as follows:

A (excellent): The change in water contact angle after reciprocation of 10,000 times is 2 degrees or less.

B (good): The change in water contact angle after reciprocation of 10,000 times is more than 2 degrees and 5 degrees or less.

C (acceptable): The change in water contact angle after reciprocation of 10,000 times is more than 5 degrees and 10 degrees or less.

D (poor): The change in water contact angle after reciprocation of 10,000 times is more than 10 degrees.

### <Antifriction Property (Steel Wool)>

The surface layer was irradiated with light (650 W/m², 300 to 700 nm) at a black panel temperature of 63° C. for 1,000 hours by using a tabletop xenon arc lamp type accelerated light resistance testing machine (manufactured by Toyo Seiki Seisaku-sho, Ltd., SUNTEST XLS+). The water contact angle was then measured by the method above. The smaller the decrease in water repellency (water contact angle) after the light irradiation, the smaller the decrease in performance due to light, and the better the light resistance. The evaluation criteria were as follows:

A (excellent): The change in water contact angle after light irradiation is 2 degrees or less.

B (good): The change in water contact angle after light irradiation is more than 2 degrees and 5 degrees or less.

C (acceptable): The change in water contact angle after light irradiation is more than 5 degrees and 10 degrees or less.

D (poor): The change in water contact angle after light irradiation is more than 10 degrees.

TABLE 1

| | | Example 1 | Example 2 | Example 3 | Example 4 | Example 5 | Example 6 | Example 7 |
|---|---|---|---|---|---|---|---|---|
| Fluorine-containing ether | | Compound | Compound | Compound | Compound | Compound II + | Compound | Compound |
| compound | | I | II | III | IV | Compound III | VI | VII |
| Dry coating | Initial contact angle | A | A | A | A | A | A | A |
| method | of water | | | | | | | |
| | Antifriction property | B | A | B | A | A | D | C |
| | Light resistance | B | A | B | A | A | D | D |
| Wet coating | Initial contact angle | A | A | A | A | A | A | A |
| method | of water | | | | | | | |
| | Antifriction property | B | A | B | A | A | D | C |
| | Light resistance | B | A | B | A | A | D | D |

As shown in Table 1, it was revealed that the surface layer formed using the present composition had excellent antifriction properties and light resistance.

In addition, various fluorine-containing ether compounds were synthesized. Synthesis examples are described below.

### Example 81

Compound 8-0 was obtained according to the synthetic method described in Example 1 of Japanese Patent No. 6044211.

CF₃CF₂—O—(CF₂O)ₘ₇—(CF₂CF₂O)ₙ₁₇—CF₂CF₂—I Formula (8-0)

However, the mean values of the repeating units m7 and n17 are 22 and 24, respectively.

### Synthesis Example 8-1

Except that compound 1-1 was changed to 5 g of compound 8-0 in Synthesis Example 2-1, 4.1 g of compound 8-1 was obtained in the same manner as in Synthesis Example 2-1.

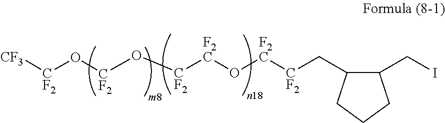

NMR spectrum of compound 8-1

¹H-NMR (400 MHz, Chloroform-d) δ (ppm): 3.5-3.0 (2H), 2.6-1.3 (10H)

¹⁹H-NMR (376 MHz, Chloroform-d) δ (ppm): −52.0-−58.2 (44F), −85.8 (2F), −89.2 (3F), −89.6-−92.3 (98F), 110.9-−115.8 (2F)

Mean value of m8: 22, and mean value of n18: 24.

### Synthesis Example 8-2

Except that compound 2-1 was changed to compound 8-1 in Synthesis Example 2-2, 1.4 g of compound 8-2 was obtained in the same manner as in Synthesis Example 2-2.

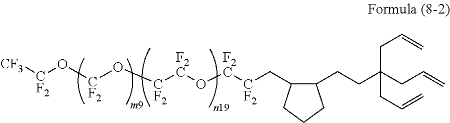

NMR spectrum of compound 8-2

¹H-NMR (400 MHz, Chloroform-d) δ (ppm): 5.9-5.7 (3H), 5.1-4.9 (6H), 2.5-1.1 (20H)

¹⁹H-NMR (376 MHz, Chloroform-d) δ (ppm): −52.0-−58.2 (44F), −85.8 (2F), −89.2 (3F), −89.6-−92.3 (98F), 110.6-−115.8 (2F) Mean value of m9: 22, and mean value of n19: 24.

### Synthesis Example 8-3

Except that compound 2-2 was changed to compound 8-2 in Synthesis Example 2-3, 1.0 g of compound (VIII) was obtained in the same manner as in Synthesis Example 2-3.

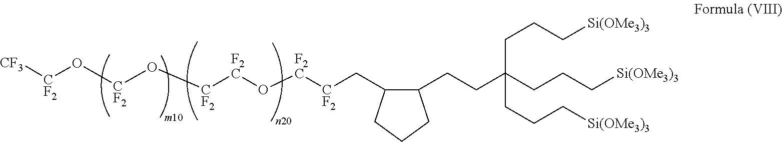

NMR spectrum of compound (8-3)

¹H-NMR (400 MHz, Chloroform-d) δ (ppm): 3.6 (27H), 2.6-0.8 (26H), 0.6 (6H)

¹⁹H-NMR (376 MHz, Chloroform-d) δ (ppm): −52.0-−58.2 (44F), −85.8 (2F), −89.2 (3F), −89.6-−92.3 (98F), 110.4-−115.7 (2F)

Mean value of m10: 22, and mean value of n20: 24.

An article with a surface layer containing the present compound is useful as, for example, a part of products such as optical articles, touch panels, antireflection film, antireflection glass, SiO₂-treated glass, tempered glass, sapphire glass, quartz substrate, and metal molds.

Products: car navigation systems, mobile phones, digital cameras, digital video cameras, portable digital assistants (PDA), portable audio players, car audio systems, game consoles, eyeglasses, camera lenses, lens filters, sunglasses, medical devices (such as gastrocameras), photocopiers, personal computers (PCs), liquid crystal displays, organic EL displays, plasma displays, touch panel displays, protective films, antireflection films, antireflection glass, nanoimprint templates, molds, etc.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound represented by formula (1) or (2):
A¹-(OR^{f1})_{y1}—R¹-Q¹-R²-L¹-(R³-T¹)ₓ₁ Formula (1)
(T³-R)ₓ₃-L³-R⁸-Q³-R⁷—R^{f}—(OR^{f2})_{y2}—R⁴-Q²-R⁵-L²-(R⁶-T²)^{x2} Formula (2)
wherein
A¹ is a fluoroalkyl group having 1 to 20 carbon atoms;
R^{f1} is a fluoroalkylene group having 1 to 6 carbon atoms, and when there is a plurality of R^{f1}, the plurality of R^{f1} is the same as or different from each other;
R¹ is a single bond or a divalent group;
Q¹ is a divalent group including one or more cyclic structures, wherein atoms constituting the cyclic structures are bonded to R¹ and R²;
R² is a single bond or a divalent group;
L¹ is a single bond or a 1+x1 valent group optionally having N, O, S, or Si and a branch point, wherein atoms bonded to R² and R³ are each independently a N, O, S, or Si atom, a carbon atom constituting the branch point, or a carbon atom having a hydroxy group or an oxo group (═O);
R³ is an alkylene group or an alkylene group having an etheric oxygen atom at a terminal on an L¹ side or between carbon-carbon atoms, and when there is a plurality of R³, the plurality of R³ is the same as or different from each other;
T¹ is —SiR^{a1}_{z1}R^{a11}_{3-z1};
R^{a1} is a hydroxy group or a hydrolyzable group, and when there is a plurality of R^{a1}, the plurality of R^{a1} is the same as or different from each other;
R^{a11} is a non-hydrolyzable group, and when there is a plurality of R^{a11}, the plurality of R^{a11} is the same as or different from each other;
z1 is an integer of 0 to 3, and when there is a plurality of z1, the plurality of z1 is the same as or different from each other, where at least one of z1 is an integer of 1 to 3;
x1 is an integer of 1 or more;
y1 is an integer of 1 or more;
R^{f} is a fluoroalkylene group having 1 to 6 carbon atoms;
R^{f2} is a fluoroalkylene group having 1 to 6 carbon atoms, and when there is a plurality of R^{f2}, the plurality of R^{f2} is the same as or different from each other;
R⁴ is a single bond or a divalent group;
Q² is a divalent group including one or more cyclic structures, wherein atoms constituting the cyclic structures are bonded to R⁴ and R⁵;
R⁵ is a single bond or a divalent group;
L² is a single bond or a 1+x2 valent group optionally having N, O, S, or Si and a branch point, wherein atoms bonded to R⁵ and R⁶ are each independently a N, O, S, or Si atom, a carbon atom constituting the branch point, or a carbon atom having a hydroxy group or an oxo group (═O);
R⁶ is an alkylene group or an alkylene group having an etheric oxygen atom at the terminal on the L² side or between carbon-carbon atoms, and when there is a plurality of R⁶, the plurality of R⁶ is the same as or different from each other;
T² is —SiR^{a2}_{z2}R^{a12}_{3-z2};
R^{a2} is a hydroxy group or a hydrolyzable group, and when there is a plurality of R^{a2}, the plurality of R^{a2} is the same as or different from each other;
R^{a12} is a non-hydrolyzable group, and when there is a plurality of R^{a12}, the plurality of R^{a12} is the same as or different from each other;
z2 is an integer of 0 to 3, and when there is a plurality of z2, the plurality of z2 is the same as or different from each other, where at least one of z2 is an integer of 1 to 3;
R⁷ is a single bond or a divalent group;
Q³ is a divalent group including one or more cyclic structures, wherein atoms constituting the cyclic structures are bonded to R⁷ and R⁸;
R⁸ is a single bond or a divalent group;
L³ is a single bond or a 1+x3 valent group optionally having N, O, S, or Si and a branch point, wherein atoms bonded to R⁸ and R⁹ are each independently a N, O, S, or Si atom, a carbon atom constituting the branch point, or a carbon atom having a hydroxy group or an oxo group (═O);
R⁹ is an alkylene group or an alkylene group having an etheric oxygen atom at the terminal on the L³ side or between carbon-carbon atoms, and when there is a plurality of R⁹, the plurality of R⁹ is the same as or different from each other;
T³ is —SiR^{a3}_{z3}R^{a13}_{3-z3};
R^{a3} is a hydroxy group or a hydrolyzable group, and when there is a plurality of R^{a3}, the plurality of R^{a3} is the same as or different from each other;
R^{a13} is a non-hydrolyzable group, and when there is a plurality of R^{a13}, the plurality of R^{a13} is the same as or different from each other;
z3 is an integer of 0 to 3, and when there is a plurality of z3, the plurality of z3 is the same as or different from each other, where at least one of z3 is an integer of 1 to 3;
X2 and x3 are each independently an integer of 1 or more; and
y2 is an integer of 1 or more.

2. The compound according to claim 1, wherein at least one of Q¹, Q², and Q³ is a divalent group containing one monocyclic or fused ring.

3. The compound according to claim 1, wherein at least one of Q¹, Q², and Q³ is a divalent group having a bonding on carbon atoms adjacent to each other that form a ring.

4. The compound according to claim 1 to wherein at least one of R¹, R⁴, and R⁷ is an alkylene group.

5. The compound according to claim 1, wherein at least one of R², R⁵, and R⁸ is a single bond or an alkylene group.

6. A composition comprising: the compound according to claim 1 and another fluorine-containing ether compound.

7. A surface treating agent comprising the compound according to claim 1.

8. A coating liquid comprising: the compound according to claim 1 and a liquid medium.

9. An article comprising: a surface layer formed of the compound according to claim 1 on a surface of a substrate.

10. A method for producing an article, comprising forming a surface layer by a dry coating method or a wet coating method using the compound according to claim 1.

11. A compound represented by formula (3) or (4):
A¹-(OR^{f1})_{y1}—R¹-Q¹-R²¹-D¹ Formula (3)
D³-R⁸¹-Q³-R⁷—R^{f}—(OR^{f2})_{y2}—R⁴-Q²-R⁵¹-D² Formula (4)
wherein
A¹ is a fluoroalkyl group having 1 to 20 carbon atoms;
R^{f1} is a fluoroalkylene group having 1 to 6 carbon atoms, and when there is a plurality of R^{f1}, the plurality of R^{f1} is the same as or different from each other;
R¹ is a single bond or a divalent group;
Q¹ is a divalent group including one or more cyclic structures, wherein atoms constituting the cyclic structures are bonded to R¹ and R²;
R²¹ is a single bond or a divalent group;
D¹ is a halogen atom;
y1 is an integer of 1 or more;
R^{f} is a fluoroalkylene group having 1 to 6 carbon atoms;
R^{f2} is a fluoroalkylene group having 1 to 6 carbon atoms, and when there is a plurality of R^{f2}, the plurality of R^{f2} is the same as or different from each other;
R⁴ is a single bond or a divalent group;
Q² is a divalent group including one or more cyclic structures, wherein atoms constituting the cyclic structures are bonded to R⁴ and R⁵;
R⁵¹ is a single bond or a divalent group;
R⁷ is a single bond or a divalent group;
Q³ is a divalent group including one or more cyclic structures, wherein atoms constituting the cyclic structures are bonded to R⁷ and R⁸;
R⁸¹ is a single bond or a divalent group;
D² and D³ are each independently a halogen atom; and
y2 is an integer of 1 or more.

12. A surface treating agent comprising the composition according to claim 6.

13. A coating liquid comprising: the composition according to claim 6 and a liquid medium.

14. An article comprising: a surface layer formed of the composition according to claim 6 on a surface of a substrate.

15. A method for producing an article, comprising forming a surface layer by a dry coating method or a wet coating method using the composition according to claim 6.
